(19) United States
(12) Patent Application Publication
(10) Pub. No.: US 2025/0337937 A1
(43) Pub. Date: Oct. 30, 2025

(54) IMMERSIVE MEDIA DATA PROCESSING

(71) Applicant: Tencent Technology (Shenzhen) Company Limited, Shenzhen (CN)

(72) Inventor: Ying HU, Shenzhen (CN)

(73) Assignee: Tencent Technology (Shenzhen) Company Limited, Shenzhen (CN)

(21) Appl. No.: 19/261,918

(22) Filed: Jul. 7, 2025

Related U.S. Application Data
(63) Continuation of application No. PCT/CN2024/074627, filed on Jan. 30, 2024.

(30) Foreign Application Priority Data
Mar. 7, 2023 (CN) 202310247101.8

(51) Int. Cl. H04N 19/46; H04N 19/136

(52) U.S. Cl. CPC H04N 19/46; H04N 19/136

(57) ABSTRACT

In a method for decoding immersive media data, a media file of immersive media is obtained. The immersive media includes N alternative bitstreams. The media file includes relationship indication information. The relationship indication information indicates an alternative relationship between the N alternative bitstreams. N is an integer greater than 1. The media file is decoded based on the relationship indication information to present the immersive media.

### RELATED APPLICATIONS

The present application is a continuation of International Application No. PCT/CN2024/074627, filed on Jan. 30, 2024, which claims priority to Chinese Patent Application No. 202310247101.8, filed on Mar. 7, 2023. The entire disclosures of the prior applications are hereby incorporated by reference.

### FIELD OF THE TECHNOLOGY

This application relates to the field of audio and video technologies, including a method for decoding immersive media data and a method for encoding immersive media data.

### BACKGROUND OF THE DISCLOSURE

Immersive media may be encoded into alternative bitstreams, to meet different presentation requirements on the immersive media. For example, two bitstreams with different coding quality but the same content are interchangeable. For another example, two bitstreams with different coding types but the same content are interchangeable. Corresponding indications need to be provided on a decoding side for a plurality of alternative bitstreams, to guide a decoding and presentation process of the immersive media.

However, existing coding standards about the immersive media do not provide clear indications for alternative bitstreams, affecting a presentation effect of the immersive media.

### SUMMARY

Aspects of this disclosure include an immersive media data processing method and apparatus, a computer device, a storage medium, and a program product, for indicating an alternative relationship between bitstreams, so as to improve a presentation effect of the immersive media.

Examples of technical solutions of this disclosure may be implemented as follows:

An aspect of this disclosure provides a method for decoding immersive media data. A media file of immersive media is obtained. The immersive media includes N alternative bitstreams. The media file includes relationship indication information. The relationship indication information indicates an alternative relationship between the N alternative bitstreams. N is an integer greater than 1. The media file is decoded based on the relationship indication information to present the immersive media.

An aspect of this disclosure provides a method for encoding immersive media data. Immersive media is encoded to obtain N alternative bitstreams. N is an integer greater than 1. Relationship indication information is generated based on an alternative relationship between the N alternative bitstreams. The relationship indication information indicates the alternative relationship between the N alternative bitstreams. The relationship indication information and the N alternative bitstreams are encapsulated to obtain a media file of the immersive media.

An aspect of this disclosure provides an apparatus for decoding immersive media data. The apparatus includes processing circuitry configured to obtain a media file of immersive media. The immersive media includes N alternative bitstreams. The media file includes relationship indication information. The relationship indication information indicates an alternative relationship between the N alternative bitstreams. N is an integer greater than 1. The processing circuitry is configured to decode the media file based on the relationship indication information to present the immersive media.

An aspect of this disclosure provides an immersive media data processing method. The method is performed by a computer device and includes: obtaining a media file of immersive media, the immersive media including N alternative bitstreams, the media file including relationship indication information, the relationship indication information being configured for indicating an alternative relationship between the N bitstreams, and N being an integer greater than 1; and decoding the media file based on the relationship indication information, to present the immersive media.

An aspect of this disclosure provides another immersive media data processing method. The method is performed by a computer device and includes: encoding immersive media, to obtain N alternative bitstreams; generating relationship indication information based on an alternative relationship between the N bitstreams, the relationship indication information being configured for indicating the alternative relationship between the N bitstreams; and encapsulating the relationship indication information and the N bitstreams, to obtain a media file of the immersive media.

An aspect of this disclosure provides an immersive media data processing apparatus. The apparatus includes: an obtaining unit, configured to obtain a media file of immersive media, the immersive media including N alternative bitstreams, the media file including relationship indication information, the relationship indication information being configured for indicating an alternative relationship between the N bitstreams, and N being an integer greater than 1; and a processing unit, configured to decode the media file based on the relationship indication information, to present the immersive media.

An aspect of this disclosure provides another immersive media data processing apparatus. The apparatus includes: an encoding unit, configured to encode immersive media, to obtain N alternative bitstreams; and a processing unit, configured to generate relationship indication information based on an alternative relationship between the N bitstreams, the relationship indication information being configured for indicating the alternative relationship between the N bitstreams. The processing unit is further configured to encapsulate the relationship indication information and the N bitstreams, to obtain a media file of the immersive media.

An aspect of this disclosure provides a computer device. The computer device includes: a processor, configured to execute a computer program; a computer-readable storage medium, the computer-readable storage medium having a computer program stored thereon, and the computer program, when executed by the processor, implementing the foregoing immersive media data processing method.

An aspect of this disclosure provides a non-transitory computer-readable storage medium having a computer-executable instructions stored therein, the computer-executable instructions, when executed by a processor, cause the processor to perform the foregoing immersive media data processing method.

An aspect of this disclosure provides a computer program product. The computer program product includes a computer program or computer instructions, and the computer program or the computer instructions, when executed by a processor, implement the foregoing immersive media data processing method.

### BRIEF DESCRIPTION OF THE DRAWINGS

To describe technical solutions in aspects of this disclosure, the accompanying drawings required for describing aspects are briefly described below. The accompanying drawings in the following description show merely some aspects of this disclosure, and a person of ordinary skill in the art may still obtain other drawings from these accompanying drawings.

FIG. 1a is a schematic diagram of 6DoF according to an aspect of this disclosure.

FIG. 1b is a schematic diagram of 3DoF according to an aspect of this disclosure.

FIG. 1c is a schematic diagram of 3DoF+ according to an aspect of this disclosure.

FIG. 2 is a diagram of an architecture of a data processing system according to an aspect of this disclosure.

FIG. 3a is a schematic diagram of an encapsulation result based on single-track encapsulation according to an aspect of this disclosure.

FIG. 3b is a schematic diagram of an encapsulation result of component-based multi-track encapsulation according to an aspect of this disclosure.

FIG. 3c is a schematic diagram of an encapsulation result of slice-based multi-track encapsulation according to an aspect of this disclosure.

FIG. 3d is a schematic diagram of another encapsulation result of slice-based multi-track encapsulation according to an aspect of this disclosure.

FIG. 4a is a flowchart of immersive media data processing according to an aspect of this disclosure.

FIG. 4b is a schematic diagram of an encapsulation result of immersive media according to an aspect of this disclosure.

FIG. 5 is a schematic flowchart of an immersive media data processing method according to an aspect of this disclosure.

FIG. 6a is a schematic flowchart of another immersive media data processing method according to an aspect of this disclosure.

FIG. 6b is a schematic diagram of content of a media file according to an aspect of this disclosure.

FIG. 7 is a schematic diagram of content of another media file according to an aspect of this disclosure.

FIG. 8a is a schematic diagram of a structure of an immersive media data processing apparatus according to an aspect of this disclosure.

FIG. 8b is a schematic diagram of a structure of another immersive media data processing apparatus according to an aspect of this disclosure.

FIG. 9 is a schematic diagram of a structure of a computer device according to an aspect of this disclosure.

### DETAILED DESCRIPTION

The following describes technical solutions in aspects of this disclosure with reference to the accompanying drawings. The described aspects are some rather than all of aspects of this disclosure. Based on aspects of this disclosure, all other aspects obtained by a person of ordinary skill in the art shall fall within the scope of this disclosure. Further, the descriptions of the terms are provided as examples only and are not intended to limit the scope of the disclosure.

The terms “first”, “second”, and the like in this disclosure are used to distinguish between same or similar terms having substantially the same functions or purposes. “First”, “second”, and “n^{th}” neither have a logical or sequential dependency relationship, nor limit the quantity and order of execution. In this disclosure, the term “at least one” means one or more, and “plurality of” means two or more. For example, a plurality of bitstreams mean two or more bitstreams, and at least one media track means one or more media tracks.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The following describes other technical terms in this disclosure:

### I. Immersive Media

The immersive media may refer to a media file that can provide immersive media content, so that a viewer immersed in the media content can obtain visual, auditory and other sensory experiences in the real world. The immersive media may include, based on degrees of freedom when the viewer views media content, as six degrees of freedom (6DoF) immersive media, 3DoF immersive media, and 3DoF+ immersive media.

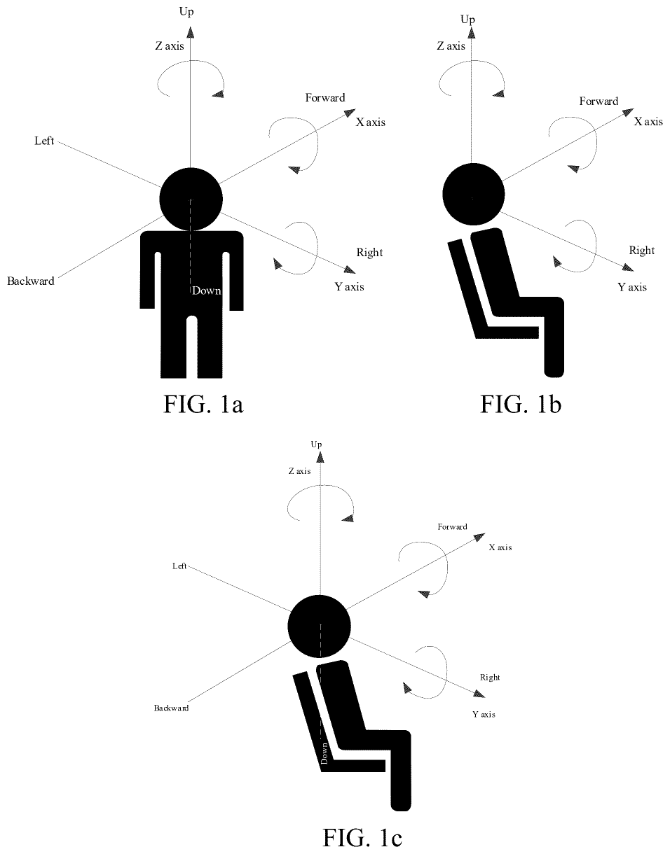

As shown in FIG. 1a, 6DoF means that a viewer of immersive media may freely translate along an X axis, a Y axis, and a Z axis. For example, the viewer of the immersive media may freely walk in three-dimensional 360-degree virtual reality (VR) content.

Similar to 6DoF, there are also 3DoF and 3DoF+ manufacturing technologies. FIG. 1b is a schematic diagram of 3DoF according to an aspect of this disclosure. As shown in FIG. 1b, 3DoF means that a viewer of immersive media is fixed at a central point of a three-dimensional space, and a head of the viewer of the immersive media rotates along an X axis, a Y axis, and a Z axis, to view an image provided by media content. FIG. 1c is a schematic diagram of 3DoF+ according to an aspect of this disclosure. As shown in FIG. 1c, 3DoF+ means that when a virtual scene provided by immersive media has depth information, and a head of a viewer of the immersive media may move in a limited space based on 3DoF, to view an image provided by media content.

Based on a time sequence characteristic of the immersive media, the immersive media includes a time-sequence immersive media and a non-time-sequence immersive media. There is a chronological order between signals in the time-sequence immersive media, and there is no chronological order between signals in the non-time-sequence immersive media.

Based on a signal characteristic of the immersive media, the immersive media includes but is not limited to volumetric media, volumetric video media, multi-viewing-angle video media, subtitle media, audio media, and the like. The volumetric media is media with three-dimensional content. For example, the volumetric media may be point cloud media (typical 6DoF immersive media).

### II. Alternative Relationship

Immersive media may be encoded into a plurality of alternative bitstreams. There is an alternative relationship between different alternative bitstreams, and the alternative relationship is a relationship in which items are interchangeable. Based on the alternative relationship between the alternative bitstreams, N alternative bitstreams are allowed to be interchanged during presentation. Different alternative bitstreams may have the same content and different quality or the same content and different coding types. For example, there is an alternative relationship between bitstreams of different resolutions obtained through encoding of point cloud media. For another example, a bitstream obtained through encoding of point cloud media in a lossy coding mode and a bitstream obtained through encoding of point cloud media in a lossless coding mode are bitstreams interchangeable with each other.

### III. Point Cloud and Point Cloud Media

The point cloud may refer to a set of discrete point that are distributed in various manners in space and express a spatial structure and a surface attribute of a three-dimensional object or scene. Each point in the point cloud includes at least geometry data, and the geometry data is configured for representing three-dimensional position information of the point. Based on different application scenarios, the point in the point cloud may further include one or more groups of attribute data. Each group of attribute data is configured for reflecting an attribute of the point. The attribute may be, for example, a color, a material, or other information. Each point in the point cloud has the same quantity of groups of attribute data.

The point cloud may flexibly and conveniently express a spatial structure and a surface attribute of a three-dimensional object or scene, and therefore is widely used in scenario including a virtual reality VR game, a computer aided design (CAD), a geographic information system (GIS), an autonomous navigation system (ANS), a digital cultural heritage, free viewpoint broadcasting, three-dimensional immersive telepresence, three-dimensional reconstruction of biological tissues and organs, and the like.

The point cloud is mainly obtained in the following ways: computer generation, three-dimensional (3D) laser scanning, 3D photogrammetry, and the like. For example, the point cloud may be obtained by capturing a visual scene in the real world by using as acquisition device (a group of cameras or a camera device having a plurality of lenses and sensors). A point cloud of a three-dimensional object or scene in the static real world may be obtained through 3D laser scanning, and a point cloud including millions of points may be obtained per second. A point cloud of a three-dimensional object or scene in the dynamic real world may be obtained through 3D photography, and a point cloud including 10 millions of points may be obtained per second. In addition, in the medical field, a point cloud of a biological tissue organ may be obtained through magnetic resonance imaging (MR), computed tomography (CT), and electromagnetic positioning information. For another example, the point cloud may alternatively be directly generated by a computer based on a virtual three-dimensional object and scene. For example, the computer may generate a point cloud of a virtual three-dimensional object and scene. With continuous accumulation of large-scale point cloud data, efficient storage, transmission, publication, sharing, and standardization of the point cloud data become the key to point cloud application.

The point cloud media includes a point cloud sequence sequentially formed by one or more point cloud frames, and each point cloud frame is jointly formed by geometry data and attribute data of one or more points in a point cloud. A point in the point cloud may include one or more groups of attribute data, and each group of attribute data is configured for reflecting an attribute of the point. For example, a point in the point cloud has a set of color attribute data, and the color attribute data is configured for reflecting a color attribute (for example, red and yellow) of the point. For another example, a point in the point cloud has a set of reflectivity attribute data, and the reflectivity attribute data is configured for reflecting a laser reflection intensity attribute of the point. When a point in the point cloud has a plurality of groups of attribute data, and types of the plurality of groups of attribute data may be the same or different. For example, the point in the point cloud may have a group of color attribute data and a group of reflectivity attribute data. For another example, a point in the point cloud may have two groups of color attribute data, and the two groups of color attribute data are respectively configured for reflecting color attributes of the point at different moments.

### IV. Track

The track may refer to a media data set in an encapsulation process of a media file, and one track includes a plurality of samples having a time sequence. One media file may include one or more tracks. For example, a video media file may include but is not limited to a video media track, an audio media track, and a subtitle media track. Particularly, metadata information may alternatively be used as a media type and included in a media file in a form of a metadata media track. The metadata information is a collective name for information related to presentation of immersive media, and the metadata information may include description information about media content of the immersive media. In aspects of this disclosure, a time-sequence immersive media is included in the media file of the immersive media in a form of a track, and the track may also be referred to as a media track.

### V. Sample

The sample may refer to an encapsulation unit in an encapsulation process of a media file, and one track is formed by many samples. For example, one video media track may be formed by many samples, and one sample is one video frame. In aspects of this disclosure, as described above, a time-sequence immersive media may be included in the media file of the time-sequence immersive media in a form of a track. The track includes one or more samples, and each sample may include one or more tactile signals in the time-sequence immersive media.

### VI. Sample Entry

The sample entry is configured for indicating metadata information related to all samples in a track. For example, a sample entry of a video media track includes metadata information related to initialization of a decoding device. For another example, a sample entry of a volumetric media track may include relationship indication information configured for indicating an alternative relationship between bitstreams.

### VII. Item

The item may refer to an encapsulation unit of non-time-sequence media data in an encapsulation process of a media file. For example, one static picture may be encapsulated into one item. In aspects of this disclosure, the non-time-sequence immersive media may be encapsulated into one or more items. In aspects of this disclosure, an item may also be referred to as a media item.

### VIII. ISO-Based Media File Format (ISOBMFF)

The ISOBMFF is a media file encapsulation standard, and a typical ISOBMFF file is an MP4 file.

### IX. Dynamic Adaptive Streaming Over HTTP (DASH)

The DASH is an adaptive bitrate technology that enables high-quality streaming media to be transferred over the Internet by using a conventional HTTP network server.

X. Media presentation description (MPD) signaling in DASH: The MPD is configured for describing media segment information in a media file.

### XI. Representation

The representation may refer to a combination of one or more media components in DASH. For example, a video file with a resolution may be considered as a representation. For example, a video file at a time-domain level may be considered as a representation.

XII. Adaptation set: The adaptation set may refer to a set of one or more video streams in DASH, and one adaptation set may include a plurality of representations. In aspects of this disclosure, the adaptation set may be referred to as adaptation for short.

Based on the foregoing related descriptions, an aspect of this disclosure provides a solution for immersive media data processing. The solution includes an immersive media processing procedure at an encoder side and an immersive media processing procedure at a decoder side.

(1) The processing procedure at the encoder side is approximately as follows:

\textcircled{1} Encode immersive media, to obtain N alternative bitstreams of the immersive media, N being an integer greater than 1.

\textcircled{2} Generate relationship indication information based on an alternative relationship between the N bitstreams of the immersive media, the relationship indication information being configured for indicating the alternative relationship between the N bitstreams.

\textcircled{3} Encapsulate the relationship indication information and the N bitstreams, to obtain a media file of the immersive media.

(2) The processing procedure at the decoder side is approximately as follows:

\textcircled{1} Obtain a media file of immersive media, the immersive media including N alternative bitstreams, the media file including relationship indication information, the relationship indication information being configured for indicating an alternative relationship between the N bitstreams, and N being an integer greater than 1.

\textcircled{2} Decode the media file based on the relationship indication information, to present the immersive media.

It can be learned from the foregoing solution that in this aspect of this disclosure, during encoding of the immersive media, the relationship indication information may be added to the media file of the immersive media. An alternative relationship between a plurality of alternative bitstreams of the immersive media may be indicated based on the relationship indication information. The decoder side may be instructed to accurately decode the immersive media based on the alternative relationship, to ensure accuracy of presenting the immersive media and improve a presentation effect of the immersive media.

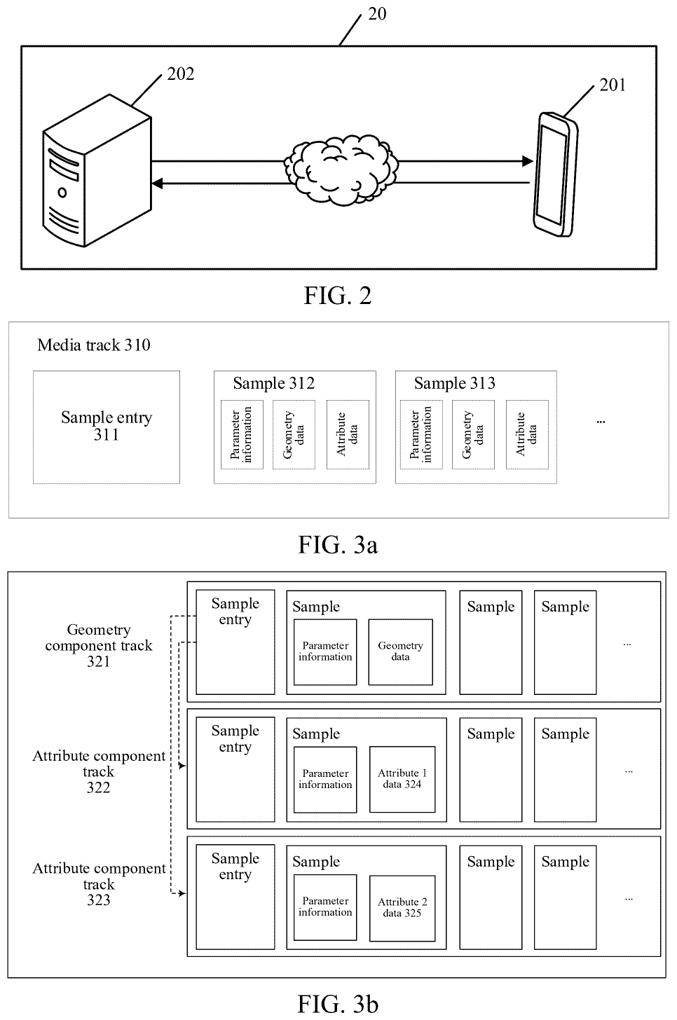

Based on the foregoing descriptions, with reference to FIG. 2, the following describes an immersive media data processing system according to an aspect of this disclosure. As shown in FIG. 2, the immersive media data processing system 20 may include a serving device 201 and a decoding device 202. The serving device 201 may be used as an immersive media encoder side, and the serving device 201 may be a terminal device or may be a server. The decoding device 202 may be used as a decoder side of the immersive media, and the decoding device 202 may be a terminal device or may be a server. A communication connection may be established between the serving device 201 and the decoding device 202. The terminal may be a smartphone, a tablet computer, a notebook computer, a desktop computer, a smart speaker, a smartwatch, a vehicle-mounted terminal, a smart television, or the like, but is not limited thereto. The cloud server may be an independent physical server, may be a server cluster or a distributed system including a plurality of physical servers, or may be a cloud server that provides basic cloud computing services, for example, a cloud service, a cloud database, cloud computing, a cloud function, cloud storage, a network service, cloud communication, a middleware service, a domain name service, a security service, a content delivery network (CDN), or a big data and artificial intelligence platform.

A specific procedure in which the serving device 201 and the decoding device 202 perform data processing on the immersive media is as follows, and for the serving device 201, the following data processing process is mainly included:
(1) a process of obtaining the immersive media; and
(2) a process of encoding the immersive media and file encapsulation.

The decoding device 202 mainly includes the following data processing process:
(3) a process of decapsulating and decoding a file of the immersive media; and
(4) a process of presenting the immersive media.

In addition, the serving device 201 and the decoding device 202 include a transmission process of the immersive media. The transmission process may be performed based on various transmission protocols (or transmission signaling). The transmission protocols herein may include but are not limited to a dynamic adaptive streaming over HTTP (DASH) protocol, an HTTP Live streaming (HLS) protocol, a smart media transport protocol (SMTP), a transmission control protocol (TCP), and the like.

The data processing process of the immersive media is described in detail below:

### (1) Process of Obtaining the Immersive Media

The serving device 201 may obtain the immersive media, and the immersive media may be obtained in two manners: scene capture or device generation.

Obtaining the immersive media in the scene capture manner means capturing a visual scene in the real world by using a capture device associated with the serving device 201 to obtain the immersive media. The capture device is configured to provide an immersive media obtaining service for the serving device 201. The capture device may include but is not limited to any one of the following: a camera device, a sensing device, and a scanning device. The camera device may include an ordinary camera, a stereoscopic camera, a light field camera, and the like. The sensing device may include a laser device, a radar device, and the like. The scanning device may include a three-dimensional laser scanning device and the like. The capture device associated with the serving device 201 may be a hardware component disposed in the serving device 201. For example, the capture device is a camera, a sensor, or the like of a terminal. The capture device associated with the serving device 201 may alternatively be a hardware apparatus connected to the serving device 201, for example, a camera connected to the serving device 201.

The device generating the immersive media means that the serving device 201 generates the immersive media based on a virtual object (for example, based on a virtual three-dimensional object or a virtual three-dimensional scene obtained through three-dimensional modeling). The foregoing immersive media may be point cloud media, or may be other media, for example, multi-viewing-angle video media, volumetric video media, audio media, tactile media, or subtitle media. The tactile media is immersive media of which media type is a tactile type, and can provide a media file of tactile sensory experience in the real world to a consumer.

### (2) Process of Encoding the Immersive Media and File Encapsulation

\textcircled{1} The serving device 201 may encode the immersive media, to obtain N alternative bitstreams of the immersive media, N being an integer greater than 1. In an implementation, the immersive media is point cloud media, and a point cloud compression (PCC) method may be used to encode the obtained point cloud media, to obtain the N alternative bitstreams of the point cloud media. For example, geometry-based point cloud compression (G-PCC) is used to encode geometry data and attribute data in the obtained point cloud media, to obtain geometry bitstreams and attribute bitstreams of different versions of the point cloud media.

\textcircled{2} The serving device 201 generates relationship indication information based on an alternative relationship between the N bitstreams of the immersive media. The alternative relationship is an interchangeable relationship between any two bitstreams. The generated relationship indication information is configured for indicating the alternative relationship between the N bitstreams.

Further, after the relationship indication information is generated, the serving device 201 may encapsulate the relationship indication information and the N bitstreams of the immersive media, to obtain a media file of the immersive media.

The encapsulating the N bitstreams of the immersive media may include the following several manners:

a. If the immersive media is time-sequence immersive media, any one of the N bitstreams of the immersive media may be encapsulated into one or more media tracks.

Any one of the N bitstreams of the immersive media may be encapsulated in a single-track encapsulation manner (in which one bitstream is encapsulated into one media track) or in a multi-track encapsulation manner (in which one bitstream is encapsulated into a plurality of media tracks). Descriptions are provided below by using an example in which the immersive media is the point cloud media. Encapsulation manners for a point cloud bitstream (that is, a bitstream of point cloud media) are described, and there are the following three encapsulation manners: (1) single-track encapsulation; (2) component-based multi-track encapsulation; and (3) slice-based multi-track encapsulation.

### (1) Single-Track Encapsulation

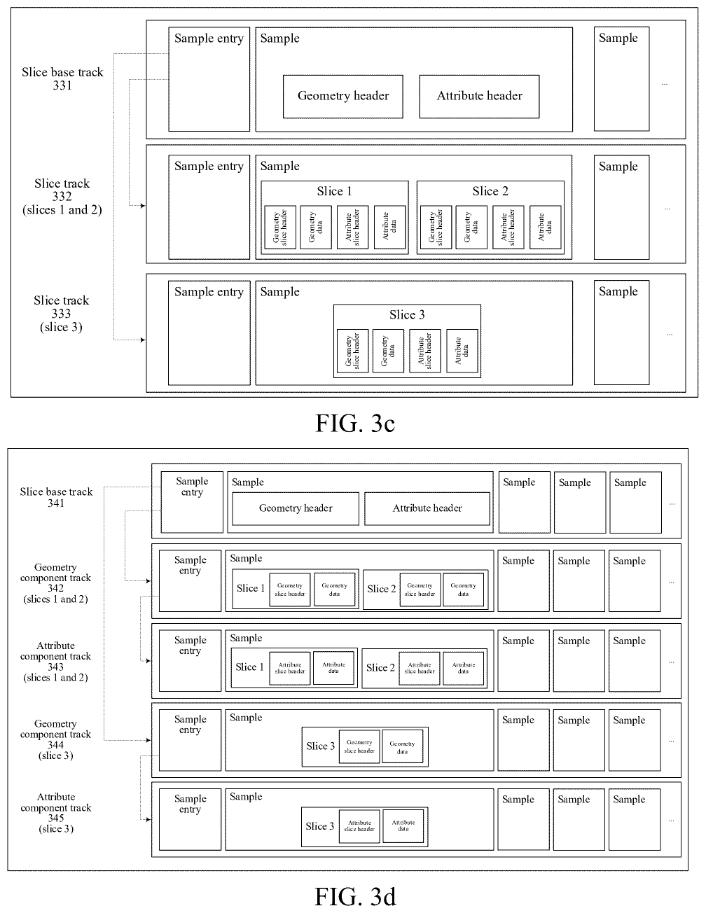

A media track may be obtained through encapsulation of a bitstream in a single-track encapsulation manner. The media track includes a sample entry and at least one sample, and each sample includes parameter information, geometry data, and attribute data. For example, FIG. 3a is a schematic diagram of an encapsulation result based on single-track encapsulation. A media track 310 obtained through encapsulation of a point cloud bitstream stores a sample 312 and a sample 313 of a geometry point cloud, and a sample entry is 311.

### (2) Multi-Track Encapsulation

A plurality of media tracks may be obtained through encapsulation of a bitstream in a multi-track encapsulation manner. According to different encapsulation units, the multi-track encapsulation manner may include component-based multi-track encapsulation and slice-based multi-track encapsulation.

In the component-based multi-track encapsulation manner, a media track into which a bitstream is encapsulated includes a geometry track and an attribute track. The geometry track includes one sample entry and at least one sample, and each sample includes parameter information and geometry data. The attribute track includes one sample entry and at least one sample, and each sample includes parameter information and attribute data. For example, FIG. 3b is a schematic diagram of an encapsulation result of component-based multi-track encapsulation. Point cloud media is encapsulated into one geometry component track 321 and two attribute component tracks 322 and 323. Different attribute component tracks include different attribute data, for example, attribute 1 data 324 and attribute 2 data 325 in FIG. 3b. The geometry component track is associated with both the two attribute component tracks, as shown by dashed arrows.

In the slice-based multi-track encapsulation manner, a bitstream may be encapsulated into a slice-based media track including one slice base track and a plurality of slice tracks. Each sample in the slice base track includes a geometry header and an attribute header. Each sample in the slice track includes one or more slices. In an implementation, each slice includes a geometry slice header, geometry data, an attribute slice header, and attribute data. For example, FIG. 3c is a schematic diagram of an encapsulation result of slice-based multi-track encapsulation. One slice base track 331 and two slice tracks 332 and 333 are included. The slice track 332 includes a slice 1 and a slice 2, the slice track 333 includes a slice 3, and the slice base track is associated with both the two slice tracks, as shown by dashed arrows.

In another implementation, the slice track may include a geometry track and an attribute track. Each slice in the geometry track includes a geometry slice header and geometry data. Each slice in the attribute track includes an attribute slice header and attribute data. The geometry track is associated with the attribute track. The slice base track may be associated with at least one geometry slice track. For example, FIG. 3d is a schematic diagram of an encapsulation result of another slice-based multi-track encapsulation. One slice base track 341, two geometry component tracks 342 and 344, and two attribute component tracks 343 and 345 are included. Geometry data and attribute data are respectively encapsulated in slices of different tracks. One geometry component track (for example, 344) is associated with one attribute component track (for example, 345), and the association is embodied in that data in samples of the geometry component track and the attribute component track is from the same slice (for example, the slice 3). The slice base track 341 is associated with the geometry component tracks 342 and 344, as shown by dashed arrows.

Any bitstream of the immersive media may be encapsulated in a single-track encapsulation manner or in a multi-track encapsulation manner, which is not limited herein in this disclosure. After the media track is obtained through encapsulation, the relationship indication information may be added to a corresponding media track, to form the media file of the immersive media. For example, the relationship indication information may be added at a sample entry of a corresponding media track. For example, setting of the relationship indication information may include the following several cases:

\textcircled{1} If any one of the N bitstreams is encapsulated into the plurality of media tracks, the relationship indication information may be added to any one of the plurality of media tracks, to indicate that a combination of the media track and another media track corresponds to one bitstream.

\textcircled{2} If any one of the N bitstreams is encapsulated into one media track, the relationship indication information may be added to the media track, to indicate an alternative relationship between a bitstream to which the media track belongs and another bitstream in the N bitstreams.

\textcircled{3} If at least two of the N bitstreams are encapsulated into the plurality of media tracks, and media tracks corresponding to any two bitstreams include the same media track, the relationship indication information may be added to the same media track, to indicate that the media track is shared by different bitstreams.

b. If the immersive media is non-time-sequence immersive media, any one of the N bitstreams of the immersive media may be encapsulated into one or more media items. In addition, the relationship indication information may be added to a corresponding media item, to form the media file of the immersive media. The addition of the relationship indication information to the corresponding media item is similar to the addition of the relationship indication information to the media track, and details are not described herein again.

After the media file of the immersive media is obtained, the serving device 201 may send the media file to the decoding device 202.

### (3) Process of Decapsulating and Decoding the File of the Immersive Media

The decoding device 202 may obtain the media file of the immersive media and description information for media presentation by using the serving device 201. The description information includes related information of the media file of the immersive media.

A decoding process of the decoding device 202 is inverse to an encoding process of the serving device 201. The decoding device 202 decapsulates the media file based on a file format requirement of the immersive media, to obtain a plurality of alternative bitstreams of the encapsulated immersive media, so as to determine a bitstream from the plurality of alternative bitstreams and decode the bitstream to restore the immersive media.

In an implementation, in the decoding process, the decoding device 202 may obtain the relationship indication information from the media file, then select a to-be-presented bitstream based on the alternative relationship indicated by the relationship indication information, organize a media track/media item corresponding to the bitstream, and decode the media track/media item to present the immersive media.

In another implementation, the immersive media may be transmitted in a streaming transmission mode. In this case, the decoding device 202 may obtain transmission signaling (for example, DASH and SMT), the transmission signaling including description information of the relationship indication information, and may determine, based on the transmission signaling, a media file segment (including one or more media tracks/one or more media items) of the immersive media that needs to be decoded for decoding, to present the immersive media.

### (4) Process of Presenting the Immersive Media

The decoding device 202 may render the bitstream obtained through the decoding. Based on a time sequence characteristic of the immersive media, for the time-sequence immersive media, rendering is performed on a media track obtained through the decoding. For the non-time-sequence immersive media, rendering is performed on a media item obtained through the decoding. For example, if the immersive media is volumetric video media, and the volumetric video media includes three media tracks, after each media track is decoded, rendering may be performed on content of the volumetric video media based on the geometry data and the attribute data included in the media track, so that the volumetric video media can be played.

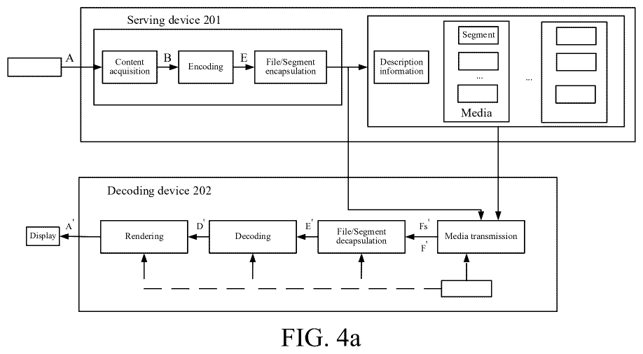

An aspect of this disclosure further provides a schematic flowchart of an immersive media data processing method. Refer to FIG. 4a. A procedure of the immersive media data processing method includes the following content:

The serving device 201 may first sample a visual scene A in the real world by using an acquisition device (for example, a group of cameras or a camera device having a plurality of lenses and sensors), to obtain source data B of the immersive media corresponding to the visual scene in the real world. For example, if the immersive media is point cloud media, the source data B is a frame sequence including a large number of point cloud frames. Then, the serving device 201 encodes the obtained immersive media, to obtain a bitstream E, and the bitstream E includes N alternative bitstreams. Next, the serving device 201 may generate relationship indication information based on an alternative relationship between the N bitstreams, and encapsulate the bitstream E and the relationship indication information to obtain a media file corresponding to the immersive media. In an implementation, in an encapsulation process, the bitstream of the immersive media may be encapsulated into one or more media tracks (or media items), and the relationship indication information is added to a corresponding media track (or media item), to form the media file of the immersive media. The serving device 201 may combine, based on a specific media container file format, one or more encoded bitstreams into a media file F for file playback or a sequence (Fs) of initialization segments and media segments for streaming transmission. The media container file format may be an ISO basic media file format specified in International Organization for Standardization (ISO)/International Electrotechnical Commission (IEC) 14496-12.

In an implementation, the serving device 201 may further generate the description information of the relationship indication information based on the alternative relationship between the N bitstreams. The description information of the relationship indication information may be sent to the decoding device 202 via transmission signaling. The decoding device 202 may determine, based on a transmission mode of the media file, whether to obtain the media file of the immersive media by using the transmission signaling. In some aspects, a form of the transmission signaling may be a signaling description file.

The decoding device 202 first receives the media file of the immersive media sent by the serving device 201. The media file may include: a media file F′ for file playback or a sequence Fs′ of initialization segments and media segments for streaming transmission. Then, the decoding device 202 decapsulates the media file, to obtain a bitstream E′. Next, the decoding device 202 obtains the relationship indication information from the media file, determines a to-be-presented bitstream from the N bitstreams based on the alternative relationship indicated by the relationship indication information, and decodes the to-be-presented bitstream, to obtain immersive media D′. The decoding device 202 may obtain, based on the transmission signaling, the initialization segments and media segments Fs′ for streaming transmission. Decoding the bitstream is decoding a media track/media item corresponding to the bitstream.

In a specific implementation, the decoding device may further determine, based on a viewing requirement (including a viewing position/viewing direction) of a current object, a media file or a media segment sequence needed for presenting the immersive media. In addition, the decoding device decodes the media file or the media segment sequence needed for presenting the immersive media, to obtain the immersive media needed for presenting. Finally, the decoding device renders the decoded immersive media based on a viewing (window) direction of the current object, to obtain a media frame A′ of the immersive media, and presents, based on presentation time of the media frame, the immersive media on a screen of a head-mounted display or any other display device carried in the decoding device. The viewing window of the current object may be determined by various types of sensors (for example, a head-following sensor, a position-following sensor, and an eye-following sensor). In a window-based transmission process, the current viewing position and viewing direction are also transmitted to a policy module, for determining a to-be-received track.

The immersive media data processing technology in this disclosure may be implemented using a cloud technology. For example, a cloud server is used as the serving device. The cloud technology is a hosting technology that integrates resources, such as hardware, software, and a network within a wide area network or a local area network, to implement data computing, storage, processing, and sharing. The immersive media data processing technology provided in this disclosure may be applied to a product related to point cloud compression or to parts such as a serving device end, a playing device end, and an intermediate node in an immersive system.

In this aspect of this disclosure, the serving device may obtain the immersive media, encode the immersive media to obtain the N alternative bitstreams, and encapsulate the N bitstreams and the relationship indication information (which is configured for indicating the alternative relationship between the bitstreams), to obtain the media file of the immersive media. Then, the decoding device may obtain the media file of the immersive media, determine, based on the alternative relationship indicated by the relationship indication information in the media file, the to-be-presented bitstream from the N bitstreams of the immersive media for decoding, and present the immersive media. It can be learned that during encoding of the immersive media, the relationship indication information may be added to the media file. In this way, the alternative relationship between the bitstreams can be indicated by the relationship indication information, to further effectively instruct the decoder side to more accurately decode and present the immersive media, so as to improve a presentation effect of the immersive media.

In a current implementation, the time-sequence immersive media may be encapsulated into one or more media tracks, the media track includes a component track, and an alternative relationship between bitstreams may be indicated by using an alternative relationship between component tracks. Interchangeable component tracks may form a track alternative group. An example in which the time-sequence immersive media is a volumetric video is used. When there is an alternative component track in a component track of the volumetric video, an alternative information structure (V3CAlternativeInfoStruct) of the volumetric video may be configured to indicate a difference between a plurality of alternative component tracks in one track alternative group. A syntax representation of the alternative information structure is shown in the following Table 1.

TABLE 1

```
aligned(8) class V3CAlternativeInfoStruct( ) {
  unsigned int(1) quality_ranking_flag;
  unsigned int(1) codec_type_flag;
  bit(6) reserved=0;
  if(quality_ranking_flag == 1){
    unsigned int(8) quality_ranking;
  }
  if(codec_type_flag == 1){
    unsigned int(32) codec_type;
  }
}
```

Meanings of the fields in the foregoing Table 1 are as follows:

Quality ranking flag field (quality_ranking_flag): A value of 1 indicates that there is an alternative relationship in quality between the component tracks in the track alternative group. A value of 0 indicates that there is no alternative relationship in quality between the alternative component tracks.

Coding type flag field (codec_type_flag): A value of 1 indicates that there is an alternative relationship in coding types between the component tracks in the track alternative group. A value of 0 indicates that there is no alternative relationship in coding types between the alternative component tracks in the track alternative group.

Quality ranking field (quality_ranking): The quality ranking field is configured for indicating quality ranking information. A smaller value of the quality ranking field indicates higher quality of a corresponding component track.

Coding type field (codec_type): The coding type field is configured for indicating a coding type of a corresponding component track.

Content of the volumetric video may be encoded into content of different versions. Different alternative content is indicated by an alternative group mechanism (an alternative group field alternate_group in a track header data box TrackHeaderBox) defined in ISO/IEC 14496-12. Image set tracks of different volumetric videos having the same value of alternate_group indicates that the content of the volumetric video corresponding to the image set tracks of the volumetric video is alternative content.

Based on the alternative relationship of the component track of the volumetric video, the interchangeable component tracks belong to the same track alternative group of one volumetric video, and only one component track in the track alternative group can be indexed by a corresponding image set track or a corresponding image set slice track. The component track includes various data of a video frame, for example, geometry data and attribute data. The image set track includes an image, for example, a video frame is encapsulated into an image set track in a form of an image. For a definition and a syntax representation of the track alternative group, refer to the following Table 2.

TABLE 2

```
\textcircled{1} Definition
Data box type: ‘valg’
Included in: TrackGroupsBox
Mandatory: no
Quantity: zero or more
\textcircled{2} Syntax
aligned(8) class V3cAlternativeTrackGroupBox extends
TrackGroupTypeBox(‘valg’) {
    //track_group_id InheritedFrom TrackGroup Type Box
    V3cAlternativeInfoStruct( );
  }
```

The track alternative group may be indicated by using a track group type data box (TrackGroupTypeBox). A type of the data box is ‘valg’, and the data box is included in the track group data box (TrackGroupBox). One media track may be provided with zero or more track group type data boxes.

For the non-time-sequence immersive media, there may be an alternative relationship between component items of the non-time-sequence immersive media. For example, if the non-time-sequence immersive media is non-time-sequence volumetric media, there is an alternative relationship between component items of the non-time-sequence volumetric media, and V3CAlternativeEntityToGroupBox is configured for indicating difference information (for example, quality difference information) between the alternative component items. Only one of the interchangeable component items can be indexed by a corresponding image set item or image set slice item. For a definition and a syntax representation of the item alternative group, refer to the following Table 3.

TABLE 3

\textcircled{1} Definition
Data box type: ‘valy’
Included in: GroupsListBox
Mandatory (per item): no
Quantity (per item): zero, one, or more
\textcircled{2} Syntax
aligned(8) class V3CAlternativeEntityToGroupBox extends
EntityToGroupBox(‘valy’) {
V3CAlternativeInfoStruct( );
}

The item alternative group is indicated by an entity group data box (EntityToGroupBox). A type of the data box is ‘valy’, and one component item may be provided with zero, one, or more entity group data boxes.

Based on the foregoing example content related to the track alternative group in the time-sequence immersive media and the item alternative group in the non-time-sequence immersive media, a corresponding data box may be set based on corresponding syntax, and is included in the media file, to indicate an alternative relationship between items/tracks.

However, in some special scenarios, the alternative relationship between the bitstreams cannot be indicated only based on the alternative relationship between the items or the tracks, affecting presentation of the immersive media. For example, refer to a schematic diagram of bitstream encapsulation shown in FIG. 4b. As shown in the section (1) of FIG. 4b, a media file 1 includes two bitstreams, and a plurality of media tracks are obtained by using multi-track encapsulation for each bitstream. A track 1 (track1) and a track 2 (track2) correspond to a bitstream 1, and the track 1 and a track 3 (track3) correspond to a bitstream 2. When geometry information in the bitstream 1 and the bitstream 2 are the same, in other words, the same coding mode is used for the geometry information, the media file 1 includes only one geometry track, in other words, the track 1, the track 2, and the track 3 are in an alternative relationship. In this case, the alternative relationship between the track 2 and the track 3 and a shared geometry track are indicated, and an alternative relationship between the bitstreams can be learned.

However, as shown in the section (2) in FIG. 4b, if a media file 2 includes a bitstream 3, and a geometry track of the bitstream 3 is not repeated (in other words, is not shared by a plurality of bitstreams), only an alternative relationship between the track 2 and the track 3 is indicated, and an alternative relationship between the bitstream 3 and another bitstream cannot be indicated. In this case, the alternative relationship between the bitstreams is not indicated enough.

It can be learned that only indicating the alternative relationship between the tracks cannot cover the alternative relationship between the bitstreams in any scenario, and the alternative relationship between the bitstreams is not indicated enough. Therefore, in this aspect of this disclosure, in the encoding process, the relationship indication information is extended to indicate an alternative relationship at a bitstream level, to support use in various file encapsulation scenarios, so as to flexibly organize the media tracks/the media items corresponding to the bitstreams, and indicate the alternative relationship between the bitstreams, with high universality.

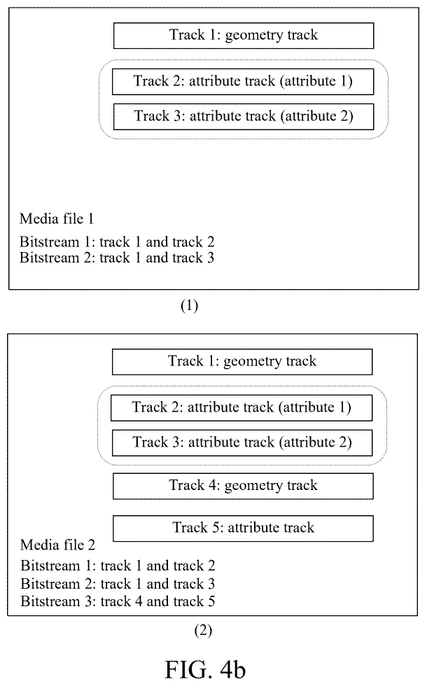

In aspects of this disclosure, several descriptive fields may be added at a system layer, including field extension at a file encapsulation layer and field extension at a signaling message layer, to support implementation operations in aspects of this disclosure. A form of extending an existing ISOBMFF data box and DASH signaling is used as an example below. FIG. 5 is a schematic flowchart of an immersive media data processing method according to an aspect of this disclosure. The immersive media data processing method may be performed by the decoding device 202 in the immersive media data processing system. The method includes the following operations S501 and S502:

S501: Obtain a media file of immersive media, the immersive media including N alternative bitstreams, the media file including relationship indication information, the relationship indication information being configured for indicating an alternative relationship between the N bitstreams, and N being an integer greater than 1. For example, a media file of immersive media is obtained. The immersive media includes N alternative bitstreams. The media file includes relationship indication information. The relationship indication information indicates an alternative relationship between the N alternative bitstreams. N is an integer greater than 1.

Based on a characteristic of a time sequence of the immersive media, the immersive media may be time-sequence immersive media or non-time-sequence immersive media. Based on a signal characteristic of the immersive media, the immersive media may be point cloud media, or may be other media. The other media is, for example, any one of multi-viewing-angle video media, audio media, subtitle media, tactile media, and volumetric video media. There is an alternative relationship between the N bitstreams of the immersive media. Any two bitstreams are interchangeable based on the alternative relationship, in other words, any two bitstreams are interchangeable bitstreams. Therefore, each of the N bitstreams may also be referred to as an alternative bitstream. For example, the immersive media includes three alternative bitstreams, which are respectively a bitstream 1, a bitstream 2, and a bitstream 3, and the three bitstreams are alternative versions of the same content of different quality. Any bitstream may be a binary bitstream or another binary bitstream (for example, a quaternary bitstream or a hexadecimal bitstream), which is not limited in this disclosure.

Next, setting of the relationship indication information in the media file and content indicated by the relationship indication information are described by using that the time-sequence immersive media is encapsulated as a media track in the media file and the non-time-sequence immersive media is encapsulated as a media item in the media file.

(1) The immersive media is the time-sequence immersive media, and the N bitstreams of the immersive media are encapsulated into M media tracks in the media file, M being an integer and being greater than or equal to N.

Because one bitstream of the time-sequence immersive media may be encapsulated into one or more media tracks in the media file, the quantity M of the media tracks is greater than or equal to the quantity N of the alternative bitstreams. The M media tracks include a corresponding quantity of different media tracks respectively corresponding to the N bitstreams, and all of the media tracks corresponding to the N bitstreams are included in one media file. For example, the three alternative bitstreams included in the immersive media are respectively the bitstream 1, the bitstream 2, and the bitstream 3. The media file includes eight media tracks, which are respectively three media tracks into which the bitstream 1 is encapsulated, four media tracks into which the bitstream 2 is encapsulated, and one media track into which the bitstream 3 is encapsulated. The media tracks of the bitstreams do not have the same media track, in other words, the bitstreams do not share a media track.

The relationship indication information may be set in the media track, and may be set in a sample entry of the media track, and may be considered as alternative information metadata of the media track to indicate the alternative relationship between the bitstreams. For ease of description, any one of the N bitstreams is represented as a bitstream i, any two of the N bitstreams may be respectively represented as a bitstream i and a bitstream j, and both i and j are positive integers and are less than or equal to N.

Based on different encapsulation manners, setting of the relationship indication information may include the following (1.1) to (1.3):

(1.1) The bitstream i is encapsulated into a media track Mᵢ in the M media tracks, and the relationship indication information is set in the media track Mᵢ.

The bitstream i of the time-sequence immersive media may be encapsulated into a single media track Mᵢ in a single-track encapsulation manner at an encoder side. The M media tracks include the media track Mᵢ, and the media track Mᵢ may be configured for indicating the bitstream i. The relationship indication information is set in the media track Mᵢ, and may be configured for indicating an alternative relationship between the bitstream i to which the media track Mᵢ belongs and another bitstream. The another bitstream herein is a bitstream other than the bitstream i in the N bitstreams.

(1.2) The bitstream i is encapsulated into a plurality of media tracks in the M media tracks, the relationship indication information is set in a media track Mᵢ, and the media track Mᵢ is any one of the plurality of media tracks into which the bitstream i is encapsulated.

The bitstream i of the non-time-sequence immersive media may alternatively be encapsulated into a plurality of media tracks in a multi-track encapsulation manner at the encoder side. The M media tracks include the plurality of media tracks corresponding to the bitstream i, the plurality of media tracks obtained through the encapsulation may be combined to represent the bitstream i, and each of the plurality of media tracks belongs to the bitstream i. The relationship indication information may be set in any one of the plurality of media tracks, that is, in the media track Mᵢ.

In a feasible implementation, when the relationship indication information is set in the media track Mᵢ in the plurality of media tracks, the relationship indication information not only may indicate the alternative relationship between the bitstream i to which the media track belongs and the another bitstream, but also may be configured for indicating an association relationship between the media track Mᵢ and another media track corresponding to the bitstream i. The another media track is a media track other than the media track Mᵢ in the plurality of media tracks into which the bitstream i is encapsulated. The association relationship is configured for indicating that the media track Mᵢ and the another media track belong to the same bitstream i. The foregoing association relationship may be a combination relationship between a plurality of media tracks that belong to the same bitstream. A combination of the media track Mᵢ and the another media track in the bitstream i may represent the bitstream i. The relationship indication information may include an indication of the association relationship.

(1.3) The bitstream i is encapsulated into a first plurality of media tracks in the M media tracks, and the bitstream j is encapsulated into a second plurality of media tracks in the M media tracks. If both the first plurality of media tracks and the second plurality of media tracks include a media track Mᵢⱼ, the relationship indication information is further configured for indicating a shared affiliation relationship of the media track Mᵢⱼ.

For any two of the N bitstreams, that is, the bitstream i and the bitstream j that use a multi-track encapsulation manner, a quantity of media tracks into which the bitstream i is encapsulated and a quantity of media tracks into which the bitstream j is encapsulated may be the same or different, but both the quantity of media tracks into which the bitstream i is encapsulated and the quantity of media tracks into which the bitstream j is encapsulated are greater than 1. For example, the bitstream i is encapsulated into three media tracks of the eight media tracks, and the bitstream j is encapsulated into two media tracks of the eight media tracks. In addition, because some information between different bitstreams may be the same, the media tracks obtained through encapsulation of different bitstreams may include the same media track. For the same media track, one media track may be retained in the media file. In this way, there is no repeated media track for the M media tracks, to effectively save storage resources. For example, the three media tracks corresponding to the bitstream i include a geometry track 1, and the two media tracks corresponding to the bitstream j include a geometry track 2. Geometry data in the bitstream i and the bitstream j is obtained in the exactly same coding mode, so that the bitstream i and the bitstream j have the same geometry track, in other words, the geometry track 1 and the geometry track 2 belong to the same media track. In this case, only one geometry track (that is, the geometry track 1 or the geometry track 2) may be retained in the media file.

The relationship indication information may be set in the media track Mᵢⱼ, and is configured for indicating the shared affiliation relationship of the media track Mᵢⱼ. The shared affiliation relationship is configured for indicating that the media track Mᵢⱼ is a media track shared by the bitstream i and the bitstream j. In other words, the media track Mᵢⱼ not only belongs to the bitstream i but also belongs to the bitstream j. Such a media track may also be referred to as a shared media track. Any shared media track may be shared by at least two bitstreams. For example, a media track in the media file is shared by three bitstreams, and a quantity of shared media tracks included in the M media tracks may be zero or more.

In addition, the media track Mᵢⱼ is one of the plurality of media tracks corresponding to the bitstream i or the bitstream j. Therefore, the relationship indication information set in the media track Mᵢⱼ may indicate the following plurality of relationships: an alternative relationship between a bitstream to which the media track Mᵢⱼ belongs and another bitstream, an association relationship between the media track Mᵢⱼ and another media track that belongs to the bitstream i/the bitstream j, and a shared affiliation relationship of the media track Mᵢⱼ. When the media track Mᵢ mentioned in (1.2) is a media track shared by different bitstreams, the relationship indication information set in the media track Mᵢ may also indicate the foregoing plurality of relationships.

It can be learned that any one or more of the following relationships may be indicated by the relationship indication information set in the media track: an alternative relationship between a bitstream to which the media track belongs and another bitstream, an association relationship between the media track and another media track that belongs to the same bitstream, and a shared affiliation relationship of the media track. The alternative relationship between the bitstreams may be indicated based on indications of the foregoing relationships, to flexibly and accurately organize media tracks corresponding to alternative bitstreams, and decode a media track corresponding to a bitstream that needs to be presented, so as to present the immersive media.

In an implementation, when a plurality of media tracks in the M media tracks need to be jointly played, the plurality of media tracks that need to be jointly played belong to the same playout track group.

Based on different joint playout requirements, media tracks may be jointly played. Media tracks that belong to the same playout track group may belong to the same bitstream, or may belong to different bitstreams. For example, for a bitstream using a multi-track encapsulation manner, the plurality of media tracks need to be combined to represent the bitstream. In this way, the plurality of media tracks in the M media tracks need to be jointly played. The plurality of media tracks that need to be jointly played belong to the same bitstream and may be classified into one playout track group. A combination of the media tracks may be indicated by the playout track group. An example in which the immersive media is time-sequence volumetric media (for example, a volumetric video) is used below. A playout track group of the volumetric video has a definition and a syntax representation shown in Table 4.

TABLE 4

```
\textcircled{1} Definition
  Data box type: ‘potg’
  Included in: TrackGroupsBox
  Mandatory: no
  Quantity: zero or more
\textcircled{2} Syntax
aligned(8) class PlayoutTrackGroupBox extends
TrackGroupTypeBox(‘potg’) {
    unsigned(1) int quality_ranking_flag;
      bit(7) reserved = 0;
    if(quality_ranking_flag == 1){
      unsigned(8) int quality_ranking;
    }
      }
```

For media tracks of the volumetric video, when only media tracks of some particular combinations are to be jointly played, the playout track group of the volumetric video may be used to indicate a combination of media tracks needed for joint playing.

For each media track in the playout track group, TrackGroupBox (a track group data box) of the media track includes PlayoutTrackGroupBox (extended from TrackGroupTypeBox in ISO/IEC 14496-12, that is, a playout track group data box) carrying unique track_group_id (a track group identifier, configured for indicating an identifier of the playout track group). PlayoutTrackGroupBox indicates that a corresponding media track belongs to one of media tracks forming one playout track group. For all of the media tracks in the playout track group, a joint quality ranking of the media tracks may be selectively defined, to indicate media content of different quality. Meanings of all of the fields in the syntax part in the foregoing Table 4 are as follows:

Quality ranking flag field (quality_ranking_flag): A value of 1 indicates that all of the media tracks of the playout track group of the volumetric video have a joint quality ranking. A value of 0 indicates that all of the media tracks of the playout track group of the volumetric video do not have a joint quality ranking.

Quality ranking field (quality_ranking): The quality ranking field is configured for indicating a joint quality ranking of all of the media tracks in the playout track group of the volumetric video. A smaller value of the quality ranking field indicates a higher ranking of joint quality.

(2) The immersive media is the non-time-sequence immersive media, the N bitstreams are encapsulated as P media items in the media file, and P is an integer and is greater than or equal to N.

A bitstream of the non-time-sequence immersive media may be encapsulated into one or more media items in the media file. The P media items include a corresponding quantity of different media items respectively corresponding to the N bitstreams, and the P media items are included in one media file.

The relationship indication information may be set in the media item. For ease of description, any one of the N bitstreams is represented as a bitstream i, any two of the N bitstreams may be respectively represented as a bitstream i and a bitstream j, and both i and j are positive integers and are less than or equal to N. Based on different encapsulation manners, setting of the relationship indication information may include the following (2.1) to (2.3):

(2.1) The bitstream i is encapsulated into a media item Pᵢ in the P media items, and the relationship indication information is set in the media item Pᵢ.

The bitstream i is encapsulated as the single media item Pᵢ and is included in the P media items. The media item Pᵢ may be configured for indicating the bitstream i. In this case, the relationship indication information is set in the media track, and may be configured for indicating an alternative relationship between the bitstream i to which the media item Mᵢ belongs and another bitstream. The another bitstream herein is a bitstream other than the bitstream i in the N bitstreams.

(2.2) The bitstream i is encapsulated into a plurality of media items in the P media items, the relationship indication information is set in a media item Pᵢ, and the media item Pᵢ is any one of the plurality of media items into which the bitstream i is encapsulated.

When the bitstream i is encapsulated into the plurality of media items, the relationship indication information may be set in any one of the plurality of media items, that is, in the media item Pᵢ.

In a feasible implementation, the relationship indication information is further configured for indicating an association relationship between the media item Pᵢ and another media item corresponding to the bitstream i. The another media item is a media item other than the media item Pᵢ in the plurality of media items into which the bitstream i is encapsulated, and the association relationship is configured for indicating that the media item Pᵢ and the another media item belong to the same bitstream i. The foregoing association relationship may be a combination relationship between a plurality of media items corresponding to the same bitstream. A combination (including all media item that belongs to the same bitstream) of the media item Pᵢ and the another media item that belongs to the bitstream i may represent the bitstream i. The relationship indication information includes an indication of the association relationship.

In some aspects, the media item Pᵢ in which the relationship indication information is set may only belong to the bitstream i, or may belong to both the bitstream i and at least one bitstream other than the bitstream i in the N bitstreams. If the media item Pᵢ belongs to at least two bitstreams, and the relationship indication information set in the media item Pᵢ further has a relationship indication in the following (2.3).

(2.3) The bitstream i is encapsulated into a first plurality of media items in the P media items, and the bitstream j is encapsulated into a second plurality of media items in the P media items. If both the first plurality of media items and the second plurality of media items include a media item Pᵢⱼ, the relationship indication information is further configured for indicating a shared affiliation relationship of the media item Pᵢⱼ. The shared affiliation relationship is configured for indicating that the media item Pᵢⱼ is a media item shared by the bitstream i and the bitstream j.

For the bitstream i and the bitstream j, a quantity of media items to which the bitstream i is encapsulated and a quantity of media items to which the bitstream j is encapsulated may be the same or different. For example, the bitstream i is encapsulated into three media items, and the bitstream j is encapsulated into two media items. In addition, because some information between different bitstreams may be the same, each media track obtained through encapsulation of different bitstreams may include the same media item. For media items repeated between different bitstreams, one media item may also be retained in the media file. In this way, storage resources can be effectively saved. For example, the media file includes seven media items. The bitstream i corresponds to three media items and the bitstream j corresponds to five media items. Both the media items corresponding to the bitstream i and the media items corresponding to the bitstream j include a media item x, and only one media item x is retained in the media file and belongs to the bitstream i and the bitstream j.

The relationship indication information may be set in the media item Pᵢⱼ, and may be configured for indicating the shared affiliation relationship of the media item Pᵢⱼ. The shared affiliation relationship is configured for indicating that the media item Pᵢⱼ is a media item shared by the bitstream i and the bitstream j. In other words, the media item Pᵢⱼ belongs to both the bitstream i and the bitstream j. Such a media item may also be referred to as a shared media item. Any shared media item may be shared by at least two bitstreams in the N bitstreams, and a quantity of shared media items included in the M media items may be zero or more.

In addition, the media item Pᵢⱼ is also a media item in the plurality of media items corresponding to the bitstream i or the bitstream j. Therefore, the relationship indication information set in the media item Pᵢⱼ may indicate the following plurality of relationships: an alternative relationship between a bitstream to which the media item Pᵢⱼ belongs and another bitstream, an association relationship between the media item Pᵢⱼ and another media item corresponding to the bitstream i/the bitstream j, and a shared affiliation relationship of the media item Pᵢⱼ. When the media item Pᵢ mentioned in (2.2) is a media item shared by different bitstreams, the relationship indication information set in the media item Pᵢ may also indicate the foregoing relationships.

Any one or more of the following relationships may be indicated by the relationship indication information set in the media item: an alternative relationship between a bitstream to which the media item belongs and another bitstream, an association relationship between the media item and another media item that belongs to the same bitstream, and a shared affiliation relationship of the media item. The alternative relationship between the bitstreams may be indicated based on indications of the foregoing relationships, to flexibly and accurately organize media tracks corresponding to alternative bitstreams, and decode a media item, so as to present the immersive media.

In a feasible implementation, when a plurality of media items in the P media items need to be jointly played, the plurality of media items that need to be jointly played belong to the same playout entity group.

Based on different joint playout requirements, different media items may be jointly played. Media items in the same playout entity group may belong to the same bitstream or different bitstreams. For example, a plurality of media items in the P media items may represent a bitstream. Therefore, when the plurality of media items representing the bitstream needs to be jointly played, the plurality of media tracks that need to be jointly played may be classified into one playout entity group. A combination of the media items played jointly may be indicated by the playout entity group. An example in which the non-time-sequence immersive media is non-time-sequence volumetric media is used below to describe a playout entity group of the non-time-sequence volumetric media. The playout entity group of the non-time-sequence volumetric media has a definition shown in the following Table 5.

TABLE 5

```
\textcircled{1} Definition
  Data box type: ‘eply’
  Included in: GroupsListBox
  Mandatory (per item): no
  Quantity (per item): zero, one, or more
\textcircled{2} Syntax
aligned(8) class PlayoutEntityToGroupBox extends
EntityToGroupBox(‘eply’) {
      unsigned int(1) quality_ranking_flag;
      bit(7) reserved = 0;
  if(quality_ranking_flag == 1){
    unsigned(8) int quality_ranking;
      }
  }
```

For media items of the volumetric media, when only media items of some particular combinations are to be jointly played, the playout entity group of the volumetric media may be used to indicate a combination of media items for joint playing. The playout entity group is represented by using a playout entity group data box PlayoutEntityToGroupBox of an ‘eply’ type, and may be set in a media item. For all of the media items in the playout entity group, a joint quality ranking of the media items may be selectively defined, to indicate media content of different quality. Meanings of all of the fields in the syntax part in the foregoing Table 5 are as follows:

Quality ranking flag field (quality_ranking_flag): A value of 1 indicates that all of the media items of the playout entity group of the volumetric media have a joint quality ranking. A value of 0 indicates that all of the media items of the playout entity group of the volumetric media do not have a joint quality ranking.

Quality ranking field (quality_ranking): The quality ranking field is configured for indicating a joint quality ranking of all of the media items in the playout entity group of the volumetric media. A smaller value of the quality ranking field indicates a higher joint quality ranking.

In an aspect, the N bitstreams having the alternative relationship belong to the same alternative group, and different bitstreams in the same alternative group are allowed to be interchanged with each other when presented. The relationship indication information includes an alternative information data box (AlternativeInfoBox). The alternative information data box has a definition shown in the following Table 6.

TABLE 6

Data box type: ‘alif’
Included in: sample entry of a media item/a media track
Mandatory: no
Quantity: zero, one, or more

The alternative information data box is a newly added data box of the type ‘alif’, and may be set in the sample entry of the media item or the media track. In other words, the sample entry of the media item or the media track may include the alternative information data box. The quantity of alternative information data boxes may be greater than or equal to zero. In other words, zero, one, or more alternative information data boxes may be set in one media track/media item. This is determined based on a characteristic of the media track/the media item. For example, if a media track track1 belongs to two bitstreams, two alternative information data boxes may be set.

The alternative information data box may be configured to indicate information about an alternative group to which a bitstream corresponding to the media track/the media item belongs: a. If the alternative information data box is set in a current media track, the alternative information data box includes information about an alternative group to which a bitstream corresponding to the current media track belongs, the current media track being a media track that is being decoded. b. If the alternative information data box is set in a current media item, the alternative information data box includes information about an alternative group to which a bitstream corresponding to the current media item belongs, the current media item being a media item that is being decoded.

If the immersive media is time-sequence immersive media, an alternative information data box may be set in one or more media tracks in the media file. If the immersive media is non-time-sequence immersive media, an alternative information data box may be set in one or more media items in the media file. For any media track or media item that is in the media file and that is being decoded, if an alternative information data box is set, information about an alternative group to which corresponding bitstream belong is indicated by the alternative information data box, to indicate an alternative relationship between the corresponding bitstreams.

In an implementation, the alternative information data box includes an alternative group identifier flag field (alternative_group_id_flag) and an alternative group identifier field (alternative_group_id). If the alternative information data box is set in the current media track, the alternative group identifier flag field is configured for indicating whether the alternative information data box in the current media track indicates an alternative group identifier of the bitstream corresponding to the current media track.

The alternative information data box may be set in a sample entry of the current media track. A value of the alternative group identifier flag field being a first preset value (for example, “0”) indicates that the alternative information data box in the current media track indicates the alternative group identifier of the bitstream corresponding to the current media track. The value of the alternative group identifier flag field being a second preset value (for example, “1”) indicates that the alternative information data box in the current media track does not indicate the alternative group identifier of the bitstream corresponding to the current media track. In some aspects, if the value of the alternative group identifier flag field is a first preset value (for example, “0”), the alternative group identifier exists in a track header data box (TrackHeaderBox) of the current media track. The alternative group identifier field (alternative_group_id) is configured for indicating the alternative group identifier of the bitstream corresponding to the current media track. Different bitstreams of the same alternative group correspond to the same alternative group identifier, and the alternative group identifier may be a value, for example, 1.

If the alternative information data box is set in the current media item, the alternative group identifier flag field is configured for indicating whether the alternative information data box in the current media item indicates an alternative group identifier of the bitstream corresponding to the current media item. Based on different values of the alternative group identifier flag field, the alternative group identifier flag field may indicate different content. The value of the alternative group identifier flag field being the first preset value (for example, “0”) indicates that the alternative information data box in the current media item indicates the alternative group identifier of the bitstream corresponding to the current media item. The value of the alternative group identifier flag field being the second preset value (for example, “1”) indicates that the alternative information data box in the current media item does not indicate the alternative group identifier of the bitstream corresponding to the current media item. The alternative group identifier field is configured for indicating the alternative group identifier of the bitstream corresponding to the current media item. Different bitstreams of the same alternative group correspond to the same alternative group identifier, and the alternative group identifier may be a value, for example, 1. The alternative group identifier may alternatively be a string of characters, for example, aabbxx.

For an alternative bitstream, the media track/the media item of the alternative information data box is set. Based on the alternative group identifier flag field and the alternative group identifier field included in the alternative information data box, the set alternative information data box may be indicated to indicate the alternative group identifier of a bitstream corresponding to the media track/the media item. Values of alternative group identifier fields in alternative information data boxes in different media tracks/media items are the same, to indicate that alternative group identifiers of corresponding bitstreams are the same.

In an aspect, the relationship indication information is further configured for indicating a shared affiliation relationship of the current media track or a shared affiliation relationship of the current media item. The shared affiliation relationship is indicated in the following two manners. One manner is to perform indication based on a field in the alternative information data box, and the other manner is to perform indication based on a quantity of alternative information data boxes.

Manner 1: Perform indication based on the field in the alternative information data box.

The alternative information data box includes a multi-alternative bitstream flag field (multi_alternative_bitstream_flag) and a bitstream number field (num_bitstream).

If the alternative information data box is set in the current media track, the multi-alternative bitstream flag field is configured for indicating whether the current media track belongs to a plurality of bitstreams. The foregoing alternative information data box may be set in a sample entry of the current media track.

A value of the multi-alternative bitstream flag field being a first preset value (for example, “0”) indicates that the current media track belongs to only one bitstream, and the current media track is a component of the bitstream. The current media track may independently represent one bitstream, or may be combined with another media track to represent one bitstream. The value of the multi-alternative bitstream flag field being a second preset value (for example, “1”) indicates that the current media track belongs to a plurality of bitstreams. The current media track is a component for all of the plurality of bitstreams. The current media track is shared by at least two bitstreams. For example, the current media track track1 is one of the plurality of media tracks corresponding to a bitstream 1, and is also one of plurality of media tracks corresponding to a bitstream 2. The bitstream number field (num_bitstream) is configured for indicating a quantity of bitstreams to which the current media track belongs. In other words, when the value of the multi-alternative bitstream flag field indicates that the current media track belongs to a plurality of bitstreams, a quantity of bitstreams to which the current media track belongs may be indicated by the bitstream number field (num_bitstream). A value of the bitstream number field is the same as the quantity of bitstreams to which the current media track belongs. For example, if the current media track belongs to K (greater than 1) bitstreams, the value of the bitstream number field may be K. For example, if the value of multi_alternative_bitstream_flag in the alternative information data box set in the current media track track1 is 1, and num_bitstream is equal to 3, it indicates that the track track1 belongs to three bitstreams, in other words, the track track1 is a media track shared by three bitstreams.

If the alternative information data box is set in the current media item, the multi-alternative bitstream flag field is configured for indicating whether the current media item belongs to a plurality of bitstreams. The value of the multi-alternative bitstream flag field (multi_alternative_bitstream_flag) being the first preset value (for example, “0”) indicates that the current media item belongs to only one bitstream, and the current media item is a component of one bitstream. The value of the multi-alternative bitstream flag field being the second preset value (for example, “1”) indicates that the current media item belongs to a plurality of bitstreams, and the current media track is a component for all of the plurality of bitstreams. The bitstream number field (num_bitstream) is configured for indicating a quantity of bitstreams to which the current media item belongs, and a value of the bitstream number field is the same as the quantity of bitstreams to which the current media item belongs.

The multi-alternative bitstream flag field and the bitstream number field may indicate whether the current media track or the current media item is shared by a plurality of bitstreams, to clarify the shared affiliation relationship of the current media track/the current media item and the quantity of bitstreams to which the current media track/the current media item belongs.

Manner 2: Perform indication based on the quantity of alternative information data boxes.

The current media track including only one alternative information data box indicates that the current media track belongs to only one bitstream. The current media track including a plurality of alternative information data boxes indicates that the current media track belongs to a plurality of bitstreams. A quantity of alternative information data boxes in the current media track is to be equal to a quantity of bitstreams to which the current media track belongs.

The quantity of alternative information data boxes in the current media track is the same as the quantity of bitstreams to which the current media track belongs, to indicate the quantity of bitstreams to which the current media track belongs. Adding the plurality of alternative information data boxes (AlternativeInfoBox) to the current media track may indicate that the current media track has a shared affiliation relationship, in other words, the current media track may be shared by the plurality of bitstreams. For the current media track that belongs to only one of the N alternative bitstreams, the current media track includes at most one alternative information data box (AlternativeInfoBox). “At most one” here means “either zero or one”. This is because that although the current media track belongs to one bitstream, the current media track may be one of the plurality of media tracks corresponding to a multi-track encapsulated bitstream rather than a single media track corresponding to a single-track encapsulated bitstream. In this case, the current media track may not need to be provided with an alternative information data box.

The current media item including only one alternative information data box indicates that the current media item belongs to only one bitstream. The current media item including a plurality of alternative information data boxes indicates that the current media item belongs to a plurality of bitstreams. A quantity of alternative information data boxes in the current media item is equal to a quantity of bitstreams to which the current media item belongs. For example, the current media item including two alternative information data boxes may indicate that the current media track belongs to two bitstreams.

In this manner, the alternative information data box does not include the multi-alternative bitstream flag field and/or the bitstream number field in Manner 1. The shared affiliation relationship of the current media track/the current media item is indicated based on the quantity of alternative information data boxes, and a shared media track/media item may be identified. This is also convenient to set corresponding information in different alternative information data boxes of the current media track/the current media item, to further indicate an association relationship between the current media track/the current media item and a corresponding media track/a corresponding media item.

In an aspect, the relationship indication information is further configured for indicating an association relationship between the current media track and another media track that belongs to the same bitstream as the current media track, or configured for indicating an association relationship between the current media item and another media item that belongs to the same bitstream as the current media item.

Based on the association relationship, the current media track and the another media track that belongs to the same bitstream may be associated with each other to represent a corresponding bitstream. The alternative information data box includes a component reference type field (components_ref_type). The component reference type field is configured for indicating an association manner between the current media track and the another media track that belongs to the same bitstream as the current media track, or is configured for indicating an association manner between the current media item and the another media item that belongs to the same bitstream as the current media item.

(1) The alternative information data box is set in the current media track.

\textcircled{1} A value of the component reference type field (component_ref_type) being a first preset value (for example, “0”) indicates that the current media track is associated, based on a track reference, with another media track that belongs to the same bitstream as the current media track. The alternative information data box further includes a track reference type field (track_ref_type), and the track reference type field is configured for indicating a type of the track reference.

The track reference is a manner for associating the current media track with another media track, and the type of the track reference is indicated by the track reference type field (track_ref_type). Content in which track reference type fields of different media tracks have the same value may indicate that the media tracks are associated with each other.

\textcircled{2} The value of the component reference type field (component_ref_type) being a second preset value (for example, “1”) indicates that the current media track is associated, based on a track group, with another media track that belongs to the same bitstream as the current media track. The alternative information data box further includes a track group type field (track_group_type) and a track group identifier field (track_group_id). The track group type field is configured for indicating a type of a track group to which the current media track belongs, and the track group identifier field is configured for indicating an identifier of the track group to which the current media track belongs.

The track group includes a plurality of media tracks. For example, based on a belonging relationship of bitstreams, the track group may be media tracks corresponding to the same bitstream, media tracks included in each track group may be combined to represent one bitstream, and M media tracks may correspond to N track groups. The type of the track group to which the current media track belongs is indicated by the track group type field (track_group_type) included in the alternative information data box, and the identifier of the track group to which the current media track belongs is indicated by the track group identifier field (track_group_id). The same track group has the same identifier and type, and the identifier may be a number or a character string, to indicate that media tracks in the track group are associated with each other.

(2) The alternative information data box is set in the current media item.

\textcircled{1} A value of the component reference type field (component_ref_type) being a third preset value (for example, “2”) indicates that the current media item is associated, based on an item reference, with another media item that belongs to the same bitstream as the current media item. The alternative information data box further includes an item reference type field (item_ref_type), and the item reference type field is configured for indicating a type of the item reference.

The item reference is a manner for associating the current media item with another media item, and the type of the item reference is indicated by the item reference type field (item_ref_type). Item reference type fields of different media items have the same value, to indicate that the media items may be associated with each other.

\textcircled{2} The value of the component reference type field (components_ref_type) being a fourth preset value (for example, “3”) indicates that the current media item is associated, based on an entity group, with another media item that belongs to the same bitstream as the current media item. The alternative information data box further includes an entity group type field (entity_group_type) and an entity group identifier field (entity_group_id). The entity group type field is configured for indicating a type of an entity group to which the current media item belongs, and the entity group identifier field is configured for indicating an identifier of the entity group to which the current media item belongs.

The entity group includes one or more media items. For example, according to a bitstream belonging characteristic, one entity group includes all media items corresponding to one bitstream, to indicate the bitstream by the entity group. The type of the entity group to which the current media item belongs is indicated by the entity group type field (entity_group_type) included in the alternative information data box, and the identifier of the entity group to which the current media item belongs is indicated by the entity group identifier field (entity_group_id). The same entity group has the same identifier and type, to indicate an association relationship between the media items in the entity group.

Based on the indication of the component reference type field (component_ref_type), a current media track and another media track or a current media item and another media item can be further associated based on values of some fields, to indicate a combination of media tracks or a combination of media items corresponding to the same bitstream. Further, with the indication for the association relationship and the shared affiliation relationship in the alternative information data box, an alternative relationship between media track combinations can be indicated, to indicate an alternative relationship at a bitstream level.

In an aspect, the alternative information data box further includes a multi-component flag field (multi_components_flag).

If the alternative information data box is set in the current media track, the multi-component flag field (multi_components_flag) is configured for indicating whether a bitstream to which the current media track belongs is encapsulated into a plurality of media tracks. The alternative information data box may be set in a sample entry of the current media track. An encapsulation manner of the bitstream to which the current media track belongs may be learned based on the multi-component flag field, to obtain a component attribute of the bitstream to which the current media track belongs. The component attribute is that the current media track is one of the plurality of media tracks into which the bitstream is encapsulated or a single media track into which the bitstream is encapsulated.

A value of the multi-component flag field (multi_components_flag) being a first preset value (for example, “0”) indicates that the bitstream to which the current media track belongs is encapsulated into one media track, and the current media track is a media track into which a bitstream to which the current media track belongs is encapsulated. The current media track belongs to a component of a single-track encapsulated bitstream, and a corresponding bitstream may be represented by using the current media track alone. The value of the multi-component flag field (multi_components_flag) being a second preset value (for example, “1”) indicates that the bitstream to which the current media track belongs is encapsulated into the plurality of media tracks, and the current media track is any one of the plurality of media tracks into which the bitstream to which the current media track belongs is encapsulated. In other words, a multi-track encapsulation manner is used for the bitstream to which the current media track belongs. The current media track is one of the plurality of media tracks into which the current media track is encapsulated, and in this case, the current media track needs to be combined with another media track that belongs to the same bitstream, to represent the bitstream.

If the alternative information data box is set in the current media item, the multi-component flag field (multi_components_flag) is configured for indicating whether a bitstream to which the current media item belongs is encapsulated into a plurality of media items. A value of the multi-component flag field being a first preset value (for example, “0”) indicates that the bitstream to which the current media item belongs is encapsulated into one media item. The current media item is a media item obtained through encapsulation of the bitstream, and the current media item alone can represent a corresponding bitstream. The current media item is a media item into which the bitstream to which the current media item belongs is encapsulated. The current media item is a media item obtained through encapsulation of the bitstream, and the current media item alone can represent a corresponding bitstream. The value of the multi-component flag field being a second preset value (for example, “1”) indicates that the bitstream to which the current media item belongs is encapsulated into a plurality of media items, and the current media item is any one of the plurality of media items into which the bitstream to which the current media item belongs is encapsulated. In this case, the current media item may be combined with another media item that belongs to the same bitstream, to represent the bitstream.

Based on the foregoing descriptions, a syntax representation in the alternative information data box may be shown in the following Table 7.

```
TABLE 7
aligned(8) class AlternativeInfoBox extends FullBox(‘alif’, version =
0, 0) {
  unsigned int(1) multi_alternative_bitstream_flag;
  unsigned int(1) alternative_group_id_flag;
  bit(6) reserved;
  if(alternative_group_id_flag == 1){
unsigned int(16) alternative_group_id;
  }
  if(multi_alternative_bitstream_flag == 1){
    unsigned int(8) num_bitstream;
    unsigned int(8) components_ref_type;
    for(int i=0; i< num_bitstream; i++){
    if(components_ref_type == 0){
  unsigned int(32) track_ref_type;
    }
  if(components_ref_type == 1){
  unsigned int(32) track_group_type;
  unsigned int(32) track_group_id;
    }
    if(components_ref_type == 2){
  unsigned int(32) item_ref_type;
    }
    if(components_ref_type == 3){
  unsigned int(32) entity_group_type;
  unsigned int(32) entity_group_id;
    }
  }
}
else{
      unsigned int(1) multi_components_flag;
      bit(7) reserved;
    if(multi_components_flag == 1)
        unsigned int(8) components_ref_type;
        if(components_ref_type == 0){
    unsigned int(32) track_ref_type;
      }
      if(components_ref_type == 1){
    unsigned int(32) track_group_type;
    unsigned int(32) track_group_id;
      }
      if(components_ref_type == 2){
    unsigned int(32) item_ref_type;
      }
      if(components_ref_type == 3){
    unsigned int(32) entity_group_type;
    unsigned int(32) entity_group_id;
      }
    }
  }
}
```

Meanings of the fields in the alternative information data box shown in the foregoing Table 7 are as follows:

Alternative group identifier flag field (alternative_group_id_flag): If the alternative information data box is set in the current media track, the alternative group identifier flag field is configured for indicating whether the alternative information data box in the current media track indicates an alternative group identifier of the bitstream corresponding to the current media track. If the alternative information data box is set in the current media item, the alternative group identifier flag field is configured for indicating whether the alternative information data box in the current media item indicates an alternative group identifier of the bitstream corresponding to the current media item. For example, a value of alternative_group_id_flag being 1 indicates that the alternative information data box in the current media track indicates an alternative group identifier of the bitstream corresponding to the current media track, and the value of alternative_group_id_flag being 0 indicates that the alternative information data box in the current media track does not indicate the alternative group identifier of the bitstream corresponding to the current media track.

Alternative group identifier field (alternative_group_id): If the alternative information data box is set in the current media track, the alternative group identifier field is configured for indicating the alternative group identifier of the bitstream corresponding to the current media track. If the alternative information data box is set in the current media item, the alternative group identifier field is configured for indicating an alternative group identifier of the bitstream corresponding to the current media item. For example, the alternative group identifier may be 1.

Multi-alternative bitstream flag field (multi_alternative_bitstream_flag): If the alternative information data box is set in the current media track, the multi-alternative bitstream flag field is configured for indicating whether the current media track belongs to a plurality of bitstreams. If the alternative information data box is set in the current media item, the multi-alternative bitstream flag field is configured for indicating whether the current media item belongs to a plurality of bitstreams.

Bitstream number field (num_bitstream): If the alternative information data box is set in the current media track, the bitstream number field is configured for indicating a quantity of bitstreams to which the current media track belongs. If the alternative information data box is set in the current media item, the bitstream number field is configured for indicating a quantity of bitstreams to which the current media item belongs.

For example, a value of multi_alternative_bitstream_flag is 1, the current media track belongs to a plurality of bitstreams, and the quantity of bitstreams is indicated by num_bitstream.

Component reference field (components_ref_type): If the alternative information data box is set in the current media track, the component reference field is configured for indicating an association manner between the current media track and another media tracks that belongs to the same bitstream as the current media track. For example, a value of components_ref_type being 0 indicates that the current media track is associated, based on a track reference, with the another media track that belongs to the same bitstream, and a track reference type field (track_ref_type) is configured for indicating a type of the track reference. The value of components_ref_type being 1 indicates that the current media track is associated, based on a track group, with the another media track that belong to the same bitstream, a type of the track group is indicated by a track group type field (track_group_type), and an identifier of the track group is indicated by a track group identifier field (track_group_id). If the alternative information data box is set in the current media item, the component reference field is configured for indicating an association manner between the current media item and another media item that belongs to the same bitstream as the current media item. For example, a value of components_ref_type being 2 indicates that the current media item is associated, based on an item reference, with the another media item that belongs to the same bitstream, and a type of the item reference is indicated by an item reference type field (item_ref_type). The value of components_ref_type being 3 indicates that the current media item is associated, based on an entity group, with the another media item that belongs to the same bitstream, a type of the entity group is indicated by an entity group type field (entity_group_type), and an identifier of the entity group is indicated by an entity group identifier field (entity_group_id).

Multi-component flag field (multi_components_flag): If the alternative information data box is set in the current media track, the multi-component flag field is configured for indicating whether the bitstream to which the current media track belongs is encapsulated into a plurality of media tracks. If the alternative information data box is set in the current media item, the multi-component flag field is configured for indicating whether the bitstream to which the current media item belongs is encapsulated into a plurality of media items.

For example, when multi_alternative_bitstream_flag indicates that the current media track belongs to a plurality of bitstreams (that is, multi_alternative_bitstream_flag==1), a bitstream number field (num_bitstream) and a component reference field (components_ref_type) may be defined. For each bitstream to which the current media track belongs, an association manner between the current media track and another media track that belongs to the same bitstream as the current media track may be indicated by using components_ref_type. However, if multi_alternative_bitstream_flag indicates that the current media track belongs to one bitstream, whether the bitstream to which the current media track belongs is encapsulated into a plurality of media tracks may be further indicated by using the multi-component flag field (multi_components_flag). If multi_components_flag indicates that the bitstream to which the current media track belongs is encapsulated into a plurality of media tracks (that is, multi_components_flag==1), a component reference field (components_ref_type) may be defined, to further indicate an association manner between the current media track and another media track that belongs to the same bitstream as the current media track.

In another implementation, if a shared affiliation relationship of the current media track/the current media item is indicated by using a quantity of alternative information data boxes, each alternative information data box has syntax shown in the following Table 8.

```
TABLE 8
aligned(8) class AlternativeInfoBox extends FullBox(‘alif’, version =
0, 0) {
  unsigned int(1) alternative_group_id_flag;
  unsigned int(1) multi_components_flag;
  bit(6) reserved;
    if(alternative_group_id_flag == 1){
  unsigned int(16) alternative_group_id;
    }
  if(multi_components_flag == 1)
      unsigned int(8) components_ref_type;
  if(components_ref_type == 0){
  unsigned int(32) track_ref_type;
      }
      if(components_ref_type == 1){
  unsigned int(32) track_group_type;
  unsigned int(32) track_group_id;
      }
      if(components_ref_type == 2){
  unsigned int(32) item_ref_type;
      }
      if(components_ref_type == 3){
  unsigned int(32) entity_group_type;
  unsigned int(32) entity_group_id;
      }
  }
}
```

It can be learned from the comparison with Table 7 that the alternative information data box includes an alternative group identifier flag field (alternative_group_id_flag), a multi-component flag field (multi_components_flag), and a component reference field (components_ref_type). For related descriptions, refer to the foregoing descriptions. Details are not described herein again. However, the alternative information data box does not include a multi-alternative bitstream flag field (multi_alternative_bitstream_flag) and determining content OF a corresponding indication. For example, the alternative information data box shown in the foregoing Table 8 is set in the current media track, and may directly indicate whether the bitstream to which the current media track belongs is encapsulated into a plurality of media tracks by using the multi-component flag field (multi_components_flag), to further define a component reference field (components_ref_type) when the bitstream to which the current media track belongs is encapsulated into a plurality of media tracks (multi_components_flag==1), so as to indicate an association manner between the current media track and another media track that belongs to the same bitstream as the current media track.

In some aspects, if the immersive media is point cloud media, and a bitstream of the point cloud media is a point cloud bitstream. A corresponding alternative information data box may be further simplified in a manner of defining a type. If the bitstream to which the current media track/the current media item belongs is a point cloud bitstream, and the point cloud bitstream is encapsulated in a multi-track encapsulation manner, the value of the multi-component flag field is the second preset value (for example, “1”). In other words, when the multi-track encapsulation manner is used for the point cloud media, it may be directly considered that the value of multi_components_flag is 1. Further, when a plurality of alternative point cloud bitstreams have a shared media track, it may be directly considered that components_ref_type is 1. Therefore, a plurality of media tracks corresponding to one point cloud bitstream may be organized by using a particular track group. Based on the foregoing descriptions, a determining result when the fields in the alternative information data box have different values may be omitted, to simplify content in the alternative information data box, so as to improve efficiency of organizing media tracks corresponding to a plurality of alternative bitstreams and save resources consumed for searching for a media track/a media item.

The media file of the immersive media is obtained in different manners based on different transmission modes of the immersive media. In an implementation, the decoding device may receive a complete media file of the immersive media, and a plurality of alternative bitstreams and relationship indication information are encapsulated in the media file. In another implementation, the immersive media is transmitted in a streaming transmission mode, and the obtaining a media file of the immersive media includes the following operations: obtaining transmission signaling of the immersive media, the transmission signaling including description information of the relationship indication information; and obtaining the media file of the immersive media based on the transmission signaling.

The transmission signaling may be DASH signaling, MPD signaling, or the like, and the transmission signaling can be obtained by the decoding device in a form of signaling description file. The description information is configured for defining the N bitstreams that are indicated by the relationship indication information and that have the alternative relationship.

In some aspects, the description information includes N preselection identifiers, and the preselection identifiers are each configured for indicating one of the N bitstreams. The preselection identifiers have the same coding identifier (for example, @gpccId=1). Each preselection identifier corresponds to one or more adaptation sets, and one adaptation set represents one media track or one media item in a bitstream represented by each preselection identifier; or each preselection identifier corresponds to one or more representations, and one representation represents one media track or one media item in a bitstream represented by each preselection identifier.

For example, the transmission signaling is DASH signaling, a preselection identifier Preselection included in the description information may be obtained through defining different components (for example, different media tracks/different media items) of the same bitstream by using a preselection tool in the DASH signaling, and Preselection is configured for representing one of the N bitstreams. The N preselection identifiers are different to indicate different bitstreams. For example, a preselection identifier Preselection1 corresponds to a bitstream 1, and a preselection identifier Preselection2 corresponds to a bitstream 2. An alternative relationship between bitstreams indicated by different preselection identifiers may be indicated by using the same coding identifier (@gpccId=1). The bitstream represented by the preselection identifier may be represented by using a combination of the adaptation set corresponding to the preselection identifier. One adaptation set includes one identifier. A quantity adaptation sets or a quantity of representations that correspond to one preselection identifier is equal to a quantity of media tracks/media items of a bitstream represented by the preselection identifier. For example, if a preselection identifier corresponds to one representation/adaptation set, it indicates that a component of a bitstream represented by the preselection identifier includes one media track or one media item.

After obtaining the transmission signaling, the decoding device may request a segment of a corresponding media file based on performance of the decoding device and a presentation requirement for the immersive media, to further decode an obtained segment of the media file for decapsulation and decoding, and present the immersive media. The performance of the decoding device includes but is not limited to a coding mode supported by the decoding device, a bandwidth supported by the decoding device, a processing capability supported by a central processing unit CPU of the decoding device, a rendering capability supported by a graphics processing unit GPU of the decoding device, and the like. The presentation requirement includes but is not limited to a presentation definition, a presentation resolution, a bite rate, a size, a viewing angle, a viewing orientation, and the like.

S502: Decode the media file based on the relationship indication information, to present the immersive media. For example, the media file is decoded based on the relationship indication information to present the immersive media.

In an aspect, the decoding the media file based on the relationship indication information, to present the immersive media may include the following operations: first determining, based on the alternative relationship indicated by the relationship indication information, a to-be-presented bitstream from the N alternative bitstreams; and decoding and presenting the to-be-presented bitstream.

In an implementation, the decoding device may obtain a complete media file. For example, the immersive media is time-sequence immersive media, the media file includes M media tracks corresponding to the N bitstreams, and the relationship indication information is set in a corresponding media track. The decoding device may first decapsulate the media file, to obtain the M media tracks, and then determine, based on the alternative relationship indicated by the relationship indication information set in the media tracks, a to-be-presented bitstream from the media tracks for decoding. The determining a to-be-presented bitstream herein is selecting, based on the relationship indication information, all media tracks that can represent the bitstream, and the media tracks may be a combination of a plurality of media tracks or a single media track. In addition, the decoding device may further determine a corresponding media track based on device performance and the presentation requirement for the immersive media of the decoding device. Next, the decoding device decodes the to-be-presented bitstream, decodes a selected media track, to present the immersive media. If the to-be-presented bitstream tis represented by using a media item, a decoded object is the media item.

In another implementation, the decoding device may obtain the media file of the immersive media based on the transmission signaling. The media file of the immersive media is obtained in a form of a segment. For example, the segment of the media file includes one or more media tracks and may represent a to-be-presented bitstream in the N bitstreams. The one or more media tracks and relationship indication information in the media track may be obtained through decapsulation of the segment of the media file, to further decode the media track based on the relationship indication information and present the immersive media. If the segment of the media file includes a media item, the media item may be decoded to present the immersive media.

According to the immersive media data processing method provided in this aspect of this disclosure, a media file of the immersive media may be obtained, the immersive media including N alternative bitstreams, the media file including relationship indication information, the relationship indication information being configured for indicating an alternative relationship between the N bitstreams, and N being an integer greater than 1. The media file is decoded based on the relationship indication information, to present the immersive media. An alternative relationship between any two bitstreams of the immersive media can be indicated by the relationship indication information. Further, accurate decoding and presentation of the immersive media are guided based on the alternative relationship, to improve a presentation effect of the immersive media. In view of this, based on encapsulation of the bitstream, the relationship indication information may be set in a corresponding media track/media item. This not only can indicate an alternative relationship at a bitstream level, but also can further support a combination relationship between a plurality of media tracks (or a plurality of media items) corresponding to the same bitstream and/or a shared affiliation relationship of a media track (or a media item) shared by different bitstreams. Based on the indication of the foregoing relationship, for any bitstream, a media track/a media item corresponding to a to-be-presented bitstream can be accurately obtained based on the relationship indication information, to present content of any version of the immersive media and improve a presentation effect of the immersive media.

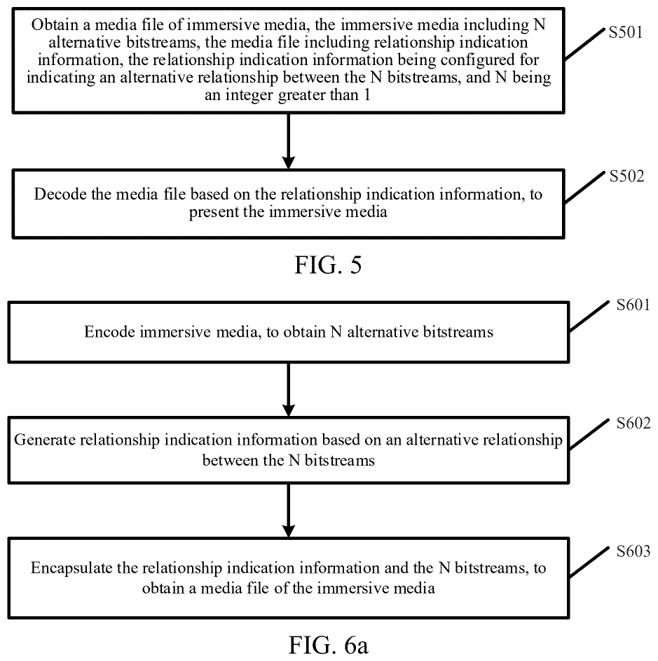

FIG. 6a is a schematic flowchart of an immersive media data processing method according to an aspect of this disclosure. The immersive media data processing method may be performed by the serving device 201 in the immersive media data processing system. The method includes the following operations S601 and S602:

S601: Encode immersive media, to obtain N alternative bitstreams. For example, immersive media is encoded to obtain N alternative bitstreams. N is an integer greater than 1.

In an implementation, the serving device may encode the immersive media in different coding modes, to obtain the N alternative bitstreams of the immersive media. In this case, the N bitstreams have the same content and different coding types. In another implementation, the immersive media may be encoded based on different quality standards, to obtain the N alternative bitstreams of the immersive media. In this case, the N bitstreams have the same content and different quality. The N alternative bitstreams may be considered as bitstreams of different versions. Any two of the N bitstreams have an alternative relationship. Based on the alternative relationship, different bitstreams are allowed to be interchanged with each other when presented. The being alternative herein includes but is not limited to any one or more of the following: being alternative in quality, being alternative in an encoding type, and being alternative in content.

S602: Generate relationship indication information based on the alternative relationship between the N bitstreams. For example, relationship indication information is generated based on an alternative relationship between the N alternative bitstreams. The relationship indication information indicates the alternative relationship between the N alternative bitstreams.

S603: Encapsulate the relationship indication information and the N bitstreams, to obtain a media file of the immersive media. For example, the relationship indication information and the N alternative bitstreams are encapsulated to obtain a media file of the immersive media.

The generated relationship indication information may be configured for indicating the alternative relationship between the N bitstreams. The serving device may encapsulate each of the N bitstreams, and add corresponding relationship indication information based on a relationship between a component (for example, a media track/a media item) obtained through encapsulation and a belonging relationship between the component and the bitstreams. In an implementation, the immersive media is time-sequence immersive media. The serving device may encapsulate the N alternative bitstreams as M media tracks (where M is greater than or equal to N). Each bitstream may be encapsulated as one or more media tracks in the M media tracks.

For ease of description, any one of the N bitstreams may be represented as a bitstream i. Based on different encapsulation manners for the bitstream i, setting of the relationship indication information at an encoder side and content of the relationship indication information are shown in the following (1) to (3).

(1) When the bitstream i is encapsulated as one media track Mᵢ, the relationship indication information may be added into the media track Mᵢ. The relationship indication information may be configured for indicating an alternative relationship between the bitstream i and another bitstream, and the another bitstream is a bitstream other than the bitstream i in the N bitstreams.

(2) When the bitstream i is encapsulated as a plurality of media tracks, the relationship indication information may be added into any one of the plurality of media tracks. The relationship indication information may be further configured for indicating an association relationship between the media track and another media track of the bitstream i, and the relationship indication information includes an indication of the association relationship. In this case, the relationship indication information added into a corresponding media track not only may be configured for indicating an alternative relationship between the bitstream i to which the media track belongs and another bitstream, but also may indicate an association relationship between the media track and another media track that belongs to the bitstream i, to indicate that a combination of the plurality of media tracks may represent the bitstream i.

(3) When at least two alternative bitstreams in the N bitstreams are encapsulated as a plurality of media tracks, and a plurality of media tracks into which different bitstreams are encapsulated include the same media track, for a media track repeating between different bitstreams, only one media track may be retained in the media file, and the relationship indication information may be added into a media track shared by the at least two bitstreams, to indicate that the media track belongs to a plurality of bitstreams at the same time. For example, in a media file 610 shown in FIG. 6b, when a bitstream 1 and a bitstream 2 have the same geometry information, in other words, when a same coding mode is used for the geometry information, one repeated geometry track may be omitted from the media file 610, in other words, the media file includes only one geometry track track1. In addition, relationship indication information may be added into the geometry track track1, to identify the geometry track track1 as a shared media track.

As described above, that the relationship indication information is set in the media track shared by the plurality of bitstreams may not only indicate that the media track is shared by the plurality of bitstreams, but also may indicate that the media track and another media track belong to the bitstream i. Based on the alternative relationship between the bitstream i and the another bitstream, it can be learned that a combination of media tracks and a media track combination representing another bitstream or a single media track are interchangeable. In the media file 610 shown in FIG. 6b, there is an alternative relationship between a track track2 and a track track3. In addition, an alternative relationship between any two combinations of the track 1 and the track 2, the track 1 and the track 3, and the track 4 and the track 5 can further be obtained based on the relationship indication information, to indicate an alternative relationship at a bitstream level, so as to more accurately and indicate the alternative relationship between the bitstreams.

The bitstream is encapsulated as a media track, and the relationship indication information is added into the corresponding media track in the foregoing manner, to form the media file of the immersive media.

In another implementation, the immersive media is non-time-sequence immersive media. The serving device may encapsulate the N alternative bitstreams as P media items. Each bitstream may be encapsulated as one or more media items in the P media items. For a bitstream i of the non-time-sequence immersive media, there are similar setting of relationship indication information and content indication in the following (4) to (6).

(4) When the bitstream i is encapsulated as one media item Mᵢ, the relationship indication information may be added into the media item Mᵢ. The relationship indication information may be configured for indicating an alternative relationship between the bitstream i and another bitstream, and the another bitstream is a bitstream other than the bitstream i in the N bitstreams.

(5) When the bitstream i is encapsulated as a plurality of media items, the relationship indication information may be added into any one of the plurality of media items. The relationship indication information may be further configured for indicating an association relationship between the media item and another media item of the bitstream i, and the relationship indication information includes an indication of the association relationship. In this case, the relationship indication information added into a corresponding media item not only may be configured for indicating an alternative relationship between the bitstream i to which the media item belongs and another bitstream, but also may indicate an association relationship between the media item and another media item that belongs to the bitstream i, to indicate that a combination of the plurality of media items may represent the bitstream i.

(6) When at least two alternative bitstreams in the N bitstreams are encapsulated as a plurality of media items, and a plurality of media items into which different bitstreams are encapsulated include the same media item, for a repeated media item corresponding to the bitstream, one media item may be retained in the media file, and the relationship indication information is added into the media item, to indicate that the media item belongs to a plurality of bitstreams at the same time.

In this aspect of this disclosure, the immersive media is encoded, the N bitstreams of the immersive media may be obtained, and there is an alternative relationship between the N bitstreams. The relationship indication information may be generated based on the alternative relationship, and the relationship indication information and the N bitstreams are encapsulated, to obtain the media file of the immersive media. It can be learned that during the encoding of the immersive media, the relationship indication information may be added into the media file, to indicate an alternative relationship between different bitstreams. In this way, an alternative relationship at a bitstream level is indicated by the relationship indication information. Based on an indication of the alternative relationship at the bitstream level, regardless of a quantity of alternative bitstreams encapsulated in the media file and a manner used for encapsulating the bitstreams, an alternative relationship between any two alternative bitstreams can be indicated by relationship indication information set in a corresponding media track/media item. In this way, a quantity of alternative bitstreams of the immersive media has sufficient compatibility, strong universality, and strong scalability. A decoder side can further flexibly organize the media track/the media item corresponding to the bitstream based on the relationship indication information, and accurately select a corresponding media track/media item, to further guide accurate presentation of decoding of the immersive media, so as to improve a presentation effect of the immersive media.

The immersive media data processing method provided in this disclosure is described in detail below by using a complete example:

1. A serving device may obtain immersive media and encode the immersive media, to obtain N alternative bitstreams.

2. The serving device generates relationship indication information based on an alternative relationship between the N bitstreams.

3. The serving device encapsulates the relationship indication information and the N bitstreams, to obtain a media file of the immersive media.

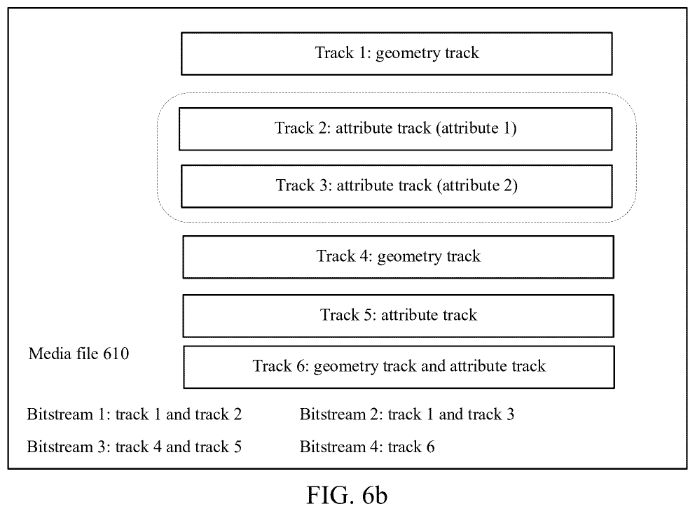

It is assumed herein that the immersive media is point cloud media, a bitstream of the immersive media is a point cloud bitstream, and a value of N is 3. Three point cloud bitstreams may be obtained by encoding the point cloud media, which are respectively denoted as a bitstream 1, a bitstream 2, and a bitstream 3, and the three point cloud bitstreams are alternative bitstreams of the same content and different quality. Geometry data of the bitstream 1 and the bitstream 2 are obtained in exactly the same coding mode, and the bitstream 1 and the bitstream 2 are encapsulated in a component-based multi-track encapsulation manner. In addition, an attribute (for example, reflectivity) in the bitstream 1 and the bitstream 2 is also obtained in exactly the same coding mode, and the bitstream 3 is encapsulated in a single-track encapsulation manner. Both a geometry track and a reflectivity attribute track in the bitstream 1 and the bitstream 2 are the same media track. Therefore, only one geometry track and only one reflectivity attribute track are retained in the media file. A schematic diagram of an encapsulation result of a media track included in the media file is shown in FIG. 7. The bitstream 1 and the bitstream 2 share a track1 geometry track and a track4 attribute track, and the bitstream 1 and the bitstream 2 have different color attribute tracks. The bitstream 1 may be represented by a combination of track1, track2, and track4, the bitstream 2 may be represented by a combination of track1, track3, and track4, and the bitstream 3 may be represented by track5. Track5 is a track (geometry and attributes track) including geometry and attribute data that is obtained by performing single-track encapsulation on the bitstream 3.

For use of alternative information metadata included in the media track and a related data box, refer to the following Table 9.

TABLE 9
Track1:
AlternativeInfoBox1:{alternative_group_id_flag =1;multi_components_flag
=1;alternative_group_id =1;components_ref_type =1;track_group_type =‘potg’;track_group_id
=1}
AlternativeInfoBox1:{alternative_group_id_flag =1;multi_components_flag
=1;alternative_group_id =1;components_ref_type =1;track_group_type =‘potg’;track_group_id
=2}
PlayoutTrackGroupBox1:{track_group_type =‘potg’;track_group_id=1}
PlayoutTrackGroupBox2:{track_group_type =‘potg’;track_group_id=2}
Track2:
PlayoutTrackGroupBox:{track_group_type =‘potg’;track_group_id=1}
Track3:
PlayoutTrackGroupBox:{track_group_type =‘potg’;track_group_id=2}
Track4:
PlayoutTrackGroupBox1:{track_group_type =‘potg’;track_group_id=1}
PlayoutTrackGroupBox2:{track_group_type =‘potg’;track_group_id=2}
Track5:
AlternativeInfoBox:{alternative_group_id_flag =1;multi_components_flag
=0;alternative_group_id =1}

Based on the settings in Table 9 above, for track1, two alternative information data boxes AlternativeInfoBox are set to indicate that track1 is shared by two bitstreams (for example, the bitstream 1 and the bitstream 2), and track group identifier fields track_group_id in different alternative information data boxes have different values. In addition, a playout track group data box PlayoutTrackGroupBox is further provided, to indicate that the playout track group data box needs to perform playing in combination with another media track. PlayoutTrackGroupBox includes a track group type field track_group_type and a track group identifier field track_group_id, and values of the track group type field and the track group identifier field are the same as values of corresponding fields in the alternative information data box. Values of track group identifier fields of media tracks that belong to the same track group are the same. The single-track encapsulation manner and the multi-track encapsulation manner may be determined based on a value of a multi-component flag field multi_components_flag (for example, a value of ( ) indicates single-track encapsulation, and a value of 1 indicates multi-track encapsulation). PlayoutTrackGroups Box is set for all of track2, track3, and track4, and this also indicates that another media track needs to be jointly played. A specific joint manner is indicated by track_group_id. For example, track1, track2, and track4 have the same track_group_id, to indicate that these tracks need to be jointly played. Similarly, track 1, track3, and track4 need to be jointly played. Only one alternative information data box AlternativeInfoBox is set in track5. In addition, an alternative group identifier is the same as an alternative group identifier included in AlternativeInfoBox in track1, and this indicates that corresponding bitstreams have an alternative relationship.

4. The serving device may transmit the media file of the immersive media to a decoding device. The transmission of the media file includes the following two transmission modes:

A: The serving device may directly transmit a complete media file F to the decoding device, and the media file includes relationship indication information.

B: The serving device may transmit one or more segments Fs (for example, including one or more media tracks of the media file) of the media file to the decoding device in a streaming transmission mode.

In a streaming transmission process, the serving device generates description information of the relationship indication information based on the alternative relationship between the bitstreams. The description information may define the N bitstreams that are indicated by the relationship indication information and that have the alternative relationship. Then the description information of the relationship indication information is sent to the decoding device by using transmission signaling. A form of the transmission signaling may be a signaling description file. The decoding device may determine the alternative relationship between the bitstreams based on the description information of the relationship indication information, and then obtain a to-be-presented bitstream based on the transmission signaling.

In the foregoing example, the serving device may generate a signaling description file based on a sharing and alternative relationship between the geometry track and the attribute track. The signaling description file includes the description information of the relationship indication information. Using DASH as an example, different components (corresponding to media tracks herein) of the same bitstream may be defined as one Preselection by using an existing preselection tool in DASH signaling, and the same coding identifier @gpccId is added to the same point cloud content to represent point cloud bitstreams of different versions. For example, track 1 to track5 included in the media file respectively correspond to adaptation sets/representations Adaptation1/Representation1 to Adaptation5/Representation5. The description information of the relationship indication information is as follows:
Preselection1: Adaptation1+Adaptation2+Adaptation4; @gpccId=1
Preselection2: Adaptation 1+Adaptation3+Adaptation4; @gpccId=1
Preselection3: Adaptation5; @gpccId=1

Adaptation1 is an adaptation set corresponding to track1, Adaptation2 is an adaptation set corresponding to track2, Adaptation3 is an adaptation set corresponding to track3, Adaptation4 is an adaptation set corresponding to track4, and Adaptation5 is an adaptation set corresponding to track5. A preselection identifier Preselection corresponds to one bitstream, and @gpccId of different preselection identifiers Preselection is equal to 1 indicates that different bitstreams are interchangeable.

5. The decoding device receives the media file of the immersive media, and the media file includes relationship indication information.

6. The decoding device decodes the media file based on the relationship indication information, to present the immersive media.

Based on different transmission modes of the media file, the decoding device may receive the complete media file F, or obtain the segment Fs of the media file based on the transmission signaling. An example in which the media file is the point cloud file F1 in the foregoing example is used.

(1) The decoding device receives the complete point cloud file F1, and the point cloud file F1 includes all media tracks corresponding to the N alternative bitstreams. The decoding device may first decapsulate the point cloud file, to obtain a media track included in the point cloud file, and then learn of, based on information about a data box set in the media track, the following three options for representing the bitstreams: \textcircled{1} track1+track2+track4; \textcircled{2} track 1+track3+track4; and \textcircled{3} track5. Next, a to-be-presented bitstream may be selected based on performance of the decoding device and a presentation requirement for the point cloud media in combination with an alternative relationship indicated by relationship indication information in the point cloud file. A track in the point cloud file F1 is selected, and the selected track is decoded based on corresponding metadata information in the point cloud file, to present the point cloud media. In this manner, because a complete media file is pre-obtained, when the decoding device needs to switch bitstreams of different versions, the decoding device may directly decode the to-be-presented bitstream, to implement more efficient switching, so as to improve presentation efficiency during immersive media switching.

(2) The decoding device first receives the signaling description file, and parses the signaling description file, to obtain the description information of the relationship indication information. It can be learned from the description information that there are following several options for the decoding device in terms of representations of the bitstreams:
Representation 1+Representation2+Representation4;
Representation 1+Representation3+Representation4; and
Representation5.

Representation1 is a representation corresponding to track 1, Representation2 is a representation corresponding to track2, Representation3 is a representation corresponding to track3, Representation4 is a representation corresponding to track4, and Representation5 is a representation corresponding to track5. Representation1+Representation2+Representation4 corresponds to the bitstream 1, Representation1+Representation3+Representation4 correspond to the bitstream 2, and Representation5 corresponds to the bitstream 3.

The decoding device may request a corresponding transmission bitstream Fs (which corresponds to one or more tracks, that is, a file segment, in the point cloud file) based on transmission signaling according to the device performance and the presentation requirement. Then, the decoding device may decapsulate the received file segment, and decode the media tracks, to finally present the point cloud media. In this manner, the decoding device does not need to receive the entire media file, but accurately obtains, based on the transmission signaling, the to-be-presented bitstream, to reduce resource consumption of presenting the immersive media once.

For the non-time-sequence immersive media, the media track in the example in the foregoing aspect is interchanged with a media item, and the same applies.

In this aspect of this disclosure, the serving device may obtain the immersive media, and encode the immersive media, to obtain the plurality of alternative bitstreams, then generate the relationship indication information based on the alternative relationship between the bitstreams, next, encapsulate the relationship indication information and the bitstreams, to obtain the media file of the immersive media, and transmit and the media file to the decoding device. The decoding device may receive the media file, decode the immersive media based on the relationship indication information included in the media file, and present the immersive media. It can be learned that in a process of encoding the immersive media (for example, in a process of encapsulating the media file), the relationship indication information is added into the media file of the immersive media, so that an alternative relationship between different bitstreams of the immersive media can be effectively indicated by using relationship indication information, to guide the decoder side to accurately present the immersive media based on the requirement of the decoder side, and improve presentation accuracy and a presentation effect of the immersive media.

Compared with a manner in which interchangeable bitstreams are encapsulated into different media files (for example, a media file F1 includes a media track corresponding to a bitstream 1, and a media file F2 includes a media track corresponding to a bitstream 2), in this aspect of this disclosure, all media tracks corresponding to the N bitstreams of the immersive media are encapsulated into one media file, and an alternative relationship between the bitstreams is indicated based on relationship indication information, which is more concise and efficient. In addition, compared with a manner in which different bitstreams are encapsulated into one media file, and media tracks into which tracks of different bitstreams are encapsulated have the same media track which repeatedly appears in the media file, in this solution, for the same media track, only one media track is retained in the media file and is shared by at least two bitstreams, and a belonging relationship between the media track and a bitstream is indicated by relationship indication information. In this way, storage resources can be saved, and a media file corresponding to a bitstream can be accurately found for decoding. Further, compared with a manner in which different bitstreams are encapsulated into one media file, repeated media tracks are omitted from the media file to indicates an alternative relationship between the media tracks, in this solution, an alternative relationship of a bitstream level instead of an alternative relationship of a track level/an item level is indicated based on relationship indication information. In this way, regardless of a quantity of bitstreams encapsulated in a media file, a corresponding media track/media item can be accurately selected based on the relationship indication information, a corresponding bitstream can be obtained through decoding, to present the immersive media, so as to achieve a good presentation effect and better universality.

Next, an immersive media data processing apparatus in aspects of this disclosure is described.

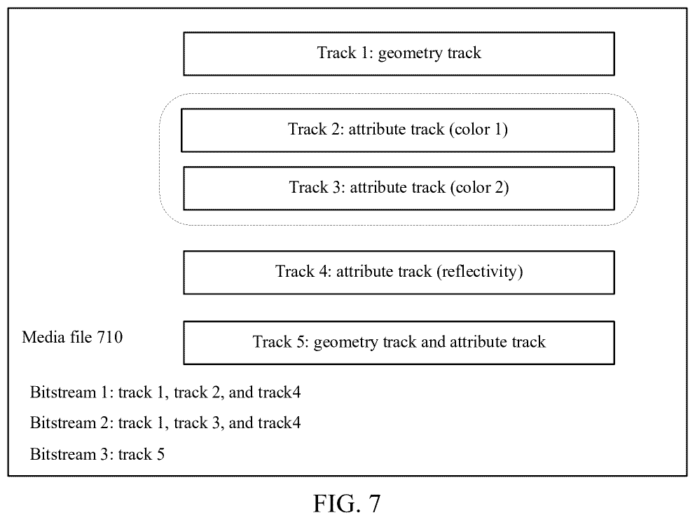

FIG. 8a is a schematic diagram of a structure of an immersive media data processing apparatus according to an aspect of this disclosure. The immersive media data processing apparatus may be disposed in a computer device provided in this aspect of this disclosure, and the computer device may be the decoding device mentioned in the foregoing method aspects. The immersive media data processing apparatus shown in FIG. 8a may be a computer program (including program code) running in the computer device. The immersive media data processing apparatus may be configured to perform some or all operations in the method aspect shown in FIG. 5. Refer to FIG. 8a. The immersive media data processing apparatus may include an obtaining unit 801 and a processing unit 802.

The obtaining unit 801 is configured to obtain a media file of immersive media, the immersive media including N alternative bitstreams, the media file including relationship indication information, the relationship indication information being configured for indicating an alternative relationship between the N bitstreams, and N being an integer greater than 1.

The processing unit 802 is configured to decode the media file based on the relationship indication information, to present the immersive media.

In an aspect, the immersive media is time-sequence immersive media, the N bitstreams are encapsulated as M media tracks in the media file, M is an integer and is greater than or equal to N, and the relationship indication information is set in the media tracks.

In an aspect, any one of the N bitstreams is represented as a bitstream i, i is a positive integer and is less than or equal to N, the bitstream i is encapsulated into a media track Mᵢ in the M media tracks, and the relationship indication information is set in the media track Mᵢ.

In an aspect, any one of the N bitstreams is represented as a bitstream i, i is a positive integer and is less than or equal to N, the bitstream i is encapsulated into a plurality of media tracks in the M media tracks, the relationship indication information is set in a media track Mᵢ, and the media track Mᵢ is any one of the plurality of media tracks into which the bitstream i is encapsulated.

In an aspect, the relationship indication information is further configured for indicating an association relationship between the media track Mᵢ and another media track different from the media track Mᵢ in the plurality of media tracks, and the association relationship is configured for indicating that the media track Mᵢ and the another media track belong to the same bitstream i.

In an aspect, any two of the N bitstreams are respectively represented as a bitstream i and a bitstream j, both i and j are positive integers and are less than or equal to N, the bitstream i is encapsulated into a first plurality of media tracks in the M media tracks, and the bitstream j is encapsulated into a second plurality of media tracks in the M media tracks; and if both the first plurality of media tracks and the second plurality of media tracks include a media track Mᵢⱼ, the relationship indication information is further configured for indicating a shared affiliation relationship of the media track Mᵢⱼ, and the shared affiliation relationship is configured for indicating that the media track Mᵢⱼ is a media track shared by the bitstream i and the bitstream j.

In an aspect, the immersive media is non-time-sequence immersive media, the N bitstreams are encapsulated as P media items in the media file, P is an integer and is greater than or equal to N, and the relationship indication information is set in the media items.

In an aspect, any one of the N bitstreams is represented as a bitstream i, i is a positive integer and is less than or equal to N, the bitstream i is encapsulated into a plurality of media items in the P media items, the relationship indication information is set in a media item Pᵢ, and the media item Pᵢ is any one of the plurality of media items into which the bitstream i is encapsulated.

In an aspect, the relationship indication information is further configured for indicating an association relationship between the media item Pᵢ and another media item different from the media item Pᵢ in the plurality of media items, and the association relationship is configured for indicating that the media item Pᵢ and the another media item belong to the same bitstream i.

In an aspect, the relationship indication information is further configured for indicating an association relationship between the media item Pᵢ and another media item corresponding to the bitstream i.

The another media item is a media item other than the media item Pᵢ in the plurality of media items into which the bitstream i is encapsulated, and the association relationship is configured for indicating that the media item Pᵢ and the another media item belong to the same bitstream i.

In an aspect, any two of the N bitstreams are respectively represented as a bitstream i and a bitstream j, both i and j are positive integers and are less than or equal to N, the bitstream i is encapsulated into a first plurality of media items in the P media items, and the bitstream j is encapsulated into a second plurality of media items in the P media items; and if both the first plurality of media items and the second plurality of media items include a media item Pᵢⱼ, the relationship indication information is further configured for indicating a shared affiliation relationship of the media item Pᵢⱼ, and the shared affiliation relationship is configured for indicating that the media item Pᵢⱼ is a media item shared by the bitstream i and the bitstream j.

In an aspect, if the immersive media is time-sequence immersive media, the N bitstreams are encapsulated as M media tracks in the media file, M is an integer and is greater than or equal to N, and when a plurality of media tracks in the M media tracks need to be jointly played, the plurality of media tracks that need to be jointly played belong to the same playout track group; or
if the immersive media is non-time-sequence immersive media, the N bitstreams are encapsulated as P media items in the media file, P is an integer and is greater than or equal to N, and when a plurality of media items in the P media items need to be jointly played, the plurality of media items that need to be jointly played belong to the same playout entity group.

In an aspect, the N bitstreams having the alternative relationship belong to the same alternative group, different bitstreams in the same alternative group are allowed to be interchanged with each other when presented, and the relationship indication information includes an alternative information data box; and
if the alternative information data box is set in a current media track, the alternative information data box includes information about an alternative group to which a bitstream corresponding to the current media track belongs; or
if the alternative information data box is set in a current media item, the alternative information data box includes information about an alternative group to which a bitstream corresponding to the current media item belongs,
the current media track being a media track that is being decoded, and the current media item being a media item that is being decoded.

In an aspect, the alternative information data box includes an alternative group identifier flag field and an alternative group identifier field; and
if the alternative information data box is set in the current media track, the alternative group identifier flag field is configured for indicating whether the alternative information data box in the current media track indicates an alternative group identifier of the bitstream corresponding to the current media track, a value of the alternative group identifier flag field being a first preset value indicating that the alternative information data box in the current media track indicates the alternative group identifier of the bitstream corresponding to the current media track; the value of the alternative group identifier flag field being a second preset value indicating that the alternative information data box in the current media track does not indicate the alternative group identifier of the bitstream corresponding to the current media track; and the alternative group identifier field being configured for indicating the alternative group identifier of the bitstream corresponding to the current media track; or
if the alternative information data box is set in the current media item, the alternative group identifier flag field is configured for indicating whether the alternative information data box in the current media item indicates an alternative group identifier of the bitstream corresponding to the current media item, a value of the alternative group identifier flag field being a first preset value indicating that the alternative information data box in the current media item indicates the alternative group identifier of the bitstream corresponding to the current media item; the value of the alternative group identifier flag field being a second preset value indicating that the alternative information data box in the current media item does not indicate the alternative group identifier of the bitstream corresponding to the current media item; and the alternative group identifier field being configured for indicating the alternative group identifier of the bitstream corresponding to the current media item.

In an aspect, the relationship indication information is further configured for indicating a shared affiliation relationship of the current media track or a shared affiliation relationship of the current media item, and the alternative information data box includes a multi-alternative bitstream flag field and a bitstream number field; and
if the alternative information data box is set in the current media track, the multi-alternative bitstream flag field is configured for indicating whether the current media track belongs to a plurality of bitstreams, a value of the multi-alternative bitstream flag field being a first preset value indicating that the current media track belongs to only one bitstream; the value of the multi-alternative bitstream flag field being a second preset value indicating that the current media track belongs to a plurality of bitstreams; and the bitstream number field is configured for indicating a quantity of bitstreams to which the current media track belongs; or
if the alternative information data box is set in the current media item, the multi-alternative bitstream flag field is configured for indicating whether the current media item belongs to a plurality of bitstreams, a value of the multi-alternative bitstream flag field being a first preset value indicating that the current media item belongs to only one bitstream; and the value of the multi-alternative bitstream flag field being a second preset value indicating that the current media item belongs to a plurality of bitstreams; and the bitstream number field is configured for indicating a quantity of bitstreams to which the current media item belongs.

In an aspect, the relationship indication information is further configured for indicating a shared affiliation relationship of the current media track or a shared affiliation relationship of the current media item; and
the current media track including only one alternative information data box indicates that the current media track belongs to only one bitstream; and the current media track including a plurality of alternative information data boxes indicates that the current media track belongs to a plurality of bitstreams, a quantity of alternative information data boxes in the current media track being equal to a quantity of bitstreams to which the current media track belongs; or
the current media item including only one alternative information data box indicates that the current media item belongs to only one bitstream; and the current media item including a plurality of alternative information data boxes indicates that the current media item belongs to a plurality of bitstreams, a quantity of alternative information data boxes in the current media item being to be equal to a quantity of bitstreams to which the current media item belongs.

In an aspect, the relationship indication information is further configured for indicating an association relationship between the current media track and another media track that belongs to the same bitstream as the current media track, or is configured for indicating an association relationship between the current media item and another media item that belongs to the same bitstream as the current media item; and
the alternative information data box includes a component reference type field, and the component reference type field is configured for indicating an association manner between the current media track and the another media track that belongs to the same bitstream as the current media track, or is configured for indicating an association manner between the current media item and the another media item that belongs to the same bitstream as the current media item,
a value of the component reference type field being a first preset value indicating that the current media track is associated, based on a track reference, with the another media track that belongs to the same bitstream as the current media track, the alternative information data box further including a track reference type field, and the track reference type field being configured for indicating a type of the track reference;
the value of the component reference type field being a second preset value indicating that the current media track is associated, based on a track group, with another media track that belongs to the same bitstream as the current media track, the alternative information data box further including a track group type field and a track group identifier field, the track group type field being configured for indicating a type of a track group to which the current media track belongs, and the track group identifier field being configured for indicating an identifier of the track group to which the current media track belongs;
the value of the component reference type field being a third preset value indicating that the current media item is associated, based on an item reference, with the another media item that belongs to the same bitstream as the current media item, the alternative information data box further including an item reference type field, and the item reference type field being configured for indicating a type of the item reference; and
the value of the component reference type field being a fourth preset value indicating that the current media item is associated, based on an entity group, with another media item that belongs to the same bitstream as the current media item, the alternative information data box further including an entity group type field and an entity group identifier field, the entity group type field being configured for indicating a type of an entity group to which the current media item belongs, and the entity group identifier field being configured for indicating an identifier of the entity group to which the current media item belongs.

In an aspect, the alternative information data box further includes a multi-component flag field; and
if the alternative information data box is set in the current media track, the multi-component flag field is configured for indicating whether a bitstream to which the current media track belongs is encapsulated into a plurality of media tracks, a value of the multi-component flag field being a first preset value indicating that the bitstream to which the current media track belongs is encapsulated into one media track, and the current media track being a media track into which a bitstream to which the current media track belongs is encapsulated; and the value of the multi-component flag field being a second preset value indicating that the bitstream to which the current media track belongs is encapsulated into the plurality of media tracks, and the current media track is any one of the plurality of media tracks into which the bitstream to which the current media track belongs is encapsulated; or
if the alternative information data box is set in the current media item, the multi-component flag field is configured for indicating whether a bitstream to which the current media track belongs is encapsulated into a plurality of media items, a value of the multi-component flag field being a first preset value indicating that the bitstream to which the current media item belongs is encapsulated into one media item, and the current media item being a media item into which the bitstream to which the current media item belongs is encapsulated; and the value of the multi-component flag field being a second preset value indicating that the bitstream to which the current media item belongs is encapsulated into a plurality of media items, and the current media item is any one of the plurality of media items into which the bitstream to which the current media item belongs is encapsulated; and
if the bitstream to which the current media track/the current media item belongs is a point cloud bitstream, and the point cloud bitstream is encapsulated in a multi-track encapsulation manner, the value of the multi-component flag field is the second preset value.

In an aspect, the immersive media is transmitted in a streaming transmission mode, and the obtaining unit 801 is configured to: obtain transmission signaling of the immersive media; and obtain the media file of the immersive media based on the transmission signaling.

In an aspect, the transmission signaling includes description information of the relationship indication information, and the description information is configured for defining the N bitstreams that are indicated by the relationship indication information and that have the alternative relationship; the description information includes N preselection identifiers, the preselection identifiers are each configured for indicating one of the N bitstreams, and the preselection identifiers have a same coding identifier; and each preselection identifier corresponds to one or more adaptation sets, and one adaptation set represents one media track or one media item in a bitstream represented by each preselection identifier; or each preselection identifier corresponds to one or more representations, and one representation represents one media track or one media item in a bitstream represented by each preselection identifier.

In an aspect, the processing unit 802 is configured to: determine, based on the alternative relationship indicated by the relationship indication information, a to-be-presented bitstream from the N alternative bitstreams; and decode and present the to-be-presented bitstream. The immersive media includes any one or more of the following: volumetric media, volumetric video media, multi-viewing-angle video media, subtitle media, and audio media.

FIG. 8b is a schematic diagram of a structure of an immersive media data processing apparatus according to an aspect of this disclosure. The immersive media data processing apparatus may be disposed in a computer device provided in this aspect of this disclosure, and the computer device may be the serving device mentioned in the foregoing method aspects. The immersive media data processing apparatus shown in FIG. 8b may be a computer program (including program code) running in the computer device. The immersive media data processing apparatus may be configured to perform some or all operations in the method aspect shown in FIG. 6a. Refer to FIG. 8b. The immersive media data processing apparatus may include an encoding unit 811 and a processing unit 812.

The encoding unit 811 is configured to encode immersive media, to obtain N alternative bitstreams.

The processing unit 812 is configured to generate relationship indication information based on an alternative relationship between the N bitstreams, the relationship indication information being configured for indicating the alternative relationship between the N bitstreams.

The processing unit 812 is further configured to encapsulate the relationship indication information and the N bitstreams, to obtain a media file of the immersive media.

In this aspect of this disclosure, an immersive media encoder side may encode the immersive media, to N bitstreams of the immersive media, and there is an alternative relationship between the N bitstreams. The relationship indication information configured for indicating the alternative relationship may be generated based on the alternative relationship, and the relationship indication information and the N bitstreams are encapsulated, to obtain the media file of the immersive media. It can be learned that during the encoding of the immersive media, the relationship indication information may be added into the media file, to indicate an alternative relationship between different bitstreams. In this way, an alternative relationship at a bitstream level is indicated by the relationship indication information. Accurate presentation of the decoding of the immersive media can be guided based on the relationship indication information, to improve a presentation effect of the immersive media.

Next, a decoding device and a serving device provided in an aspect of this disclosure are described.

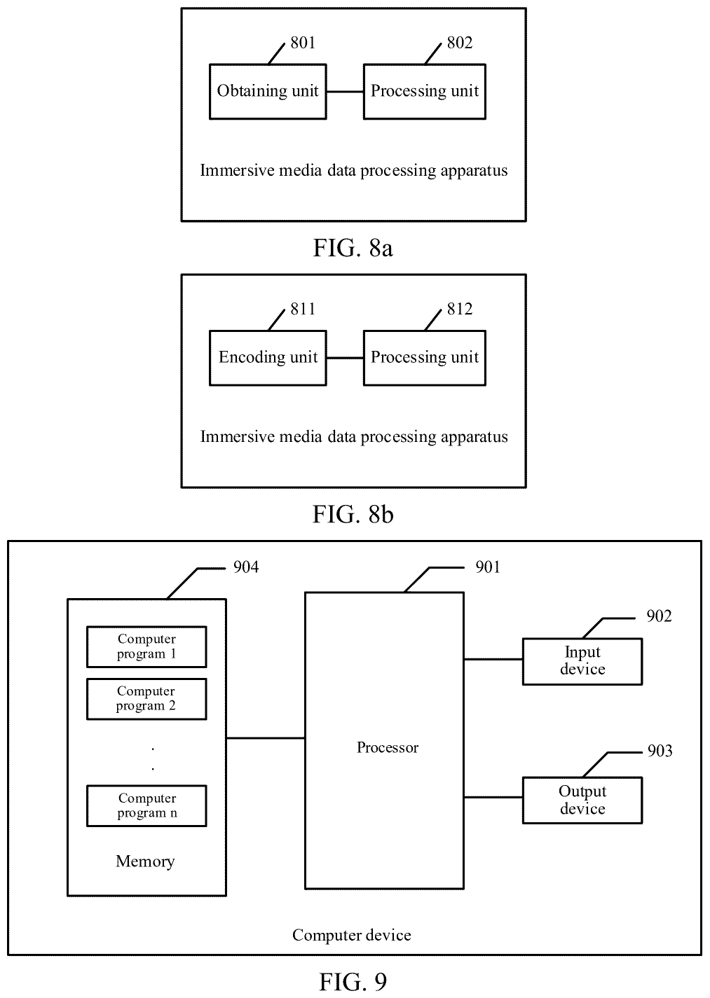

An aspect of this disclosure further provides a schematic diagram of a structure of a computer device. For the schematic diagram of the structure of the computer device, refer to FIG. 9. The computer device may include processing circuitry, such as a processor 901, an input device 902, an output device 903, and a memory 904. The processor 901, the input device 902, the output device 903, and the memory 904 are connected via a bus. The memory 904 is configured to store a computer program, and the computer program includes program instructions. The processor 901 is configured to execute the program instructions stored in the memory 904.

In an aspect, the computer device may be the foregoing decoding device. In this aspect, the processor 901 performs, by running executable program code in the memory 904, the foregoing immersive media data processing method.

In addition, an aspect of this disclosure further provides a computer-readable storage medium such as a non-transitory computer-readable storage medium. The computer-readable storage medium has a computer program stored thereon, and the computer program includes program instructions. When executing the foregoing program instructions, a processor can perform the methods in aspects corresponding to FIG. 5 and FIG. 6a. Therefore, details are not described herein again. For technical details that are not disclosed in the aspect of the computer-readable storage medium in this disclosure, refer to descriptions of the method aspects of this disclosure. In an example, the program instructions may be distributed on a computer device, or executed on a plurality of computer devices located in one location, or executed on a plurality of computer devices distributed in a plurality of locations and interconnected via a communication network.

According to an aspect of this disclosure, a computer program product is provided. The computer program product includes a computer program, and the computer program is stored on a computer-readable storage medium. A processor of a computer device reads the computer program from the computer-readable storage medium, and the processor executes the computer program, so that the computer device may perform the methods in aspects corresponding to FIG. 5 and FIG. 6a. Therefore, details are not described herein again.

A person of ordinary skill in the art may understand that all or part of procedures of the method in the foregoing aspects may be implemented by a computer program instructing relevant hardware. The program may be stored in a computer-readable storage medium. When the program is executed, the procedures in the foregoing method aspects may be implemented. The foregoing storage medium may be a magnetic disc, an optical disc, a read-only memory (ROM), a random access memory (RAM), or the like.

The foregoing descriptions are merely some examples aspects of this disclosure, and are not intended to limit the scope of this disclosure. A person of ordinary skill in the art may understand all or part of procedures for implementing the foregoing aspects and equivalent variations disclosure shall fall within the scope of this disclosure.

What is claimed is:

1. A method for decoding immersive media data, the method comprising:
obtaining a media file of immersive media, the immersive media including N alternative bitstreams, the media file including relationship indication information, the relationship indication information indicating an alternative relationship between the N alternative bitstreams, and N being an integer greater than 1; and
decoding the media file based on the relationship indication information to present the immersive media.

2. The method according to claim 1, wherein the immersive media includes time-sequence immersive media, the N alternative bitstreams are encapsulated in M media tracks in the media file, and M is an integer and is greater than or equal to N; and the relationship indication information is set in at least one of the M media tracks.

3. The method according to claim 2, wherein a bitstream i of the N alternative bitstreams is encapsulated into a media track Mᵢ of the M media tracks, i being a positive integer less than or equal to N; and the relationship indication information is set in the media track Mᵢ.

4. The method according to claim 2, wherein
a bitstream i of the N alternative bitstreams is encapsulated into a plurality of media tracks of the M media tracks, i being a positive integer less than or equal to N; and
the relationship indication information is set in a media track Mᵢ, the media track Mᵢ being one of the plurality of media tracks.

5. The method according to claim 4, wherein the relationship indication information indicates an association relationship between the media track Mᵢ and at least one other media track of the plurality of media tracks, and the association relationship indicates that the media track Mᵢ and the at least one other media track belong to the bitstream i.

6. The method according to claim 1, wherein the immersive media includes non-time-sequence immersive media, the N alternative bitstreams are encapsulated as P media items in the media file, and P is an integer greater than or equal to N; and
the relationship indication information is set in at least one of the P media items.

7. The method according to claim 1, wherein the N alternative bitstreams belong to an alternative group, bitstreams in the alternative group being interchangeable during presentation, and the relationship indication information including an alternative information data box.

8. The method according to claim 7, wherein the alternative information data box includes an alternative group identifier flag indicating whether the alternative information data box specifies an alternative group identifier, and an alternative group identification information indicating the alternative group identifier when the alternative group identifier flag has a first value.

9. The method according to claim 7, wherein the alternative information data box includes a multi-alternative bitstream flag indicating whether a current media track belongs to multiple bitstreams of the N alternative bitstreams, and bitstream number information indicating a quantity of bitstreams to which the current media track belongs when the multi-alternative bitstream flag has a first value.

10. The method according to claim 1, wherein the decoding the media file comprises:
determining a to-be-presented bitstream from the N alternative bitstreams based on the alternative relationship indicated by the relationship indication information; and
decoding the to-be-presented bitstream.

11. The method according to claim 1, wherein the obtaining the media file comprises:
obtaining signaling information of the immersive media, the signaling information including description information of the relationship indication information; and
obtaining at least a portion of the media file based on the signaling information.

12. A method for encoding immersive media data, the method comprising:
encoding immersive media to obtain N alternative bitstreams, N being an integer greater than 1;
generating relationship indication information based on an alternative relationship between the N alternative bitstreams, the relationship indication information indicating the alternative relationship between the N alternative bitstreams; and
encapsulating the relationship indication information and the N alternative bitstreams to obtain a media file of the immersive media.

13. The method according to claim 12, wherein
the immersive media includes time-sequence immersive media, and
the encapsulating the relationship indication information and the N alternative bitstreams includes encapsulating the N alternative bitstreams as M media tracks, M being an integer greater than or equal to N; and
the relationship indication information is included in at least one of the M media tracks.

14. The method according to claim 13, wherein
when a bitstream i of the N alternative bitstreams is encapsulated as a plurality of media tracks,
the relationship indication information is included in one of the plurality of media tracks, the relationship indication information indicating both the alternative relationship between the bitstream i and at least one other bitstream of the N alternative bitstreams and an association relationship between the plurality of media tracks.

15. The method according to claim 13, wherein
when at least two bitstreams of the N alternative bitstreams share a media track, t
the relationship indication information is included in the shared media track to indicate a shared affiliation relationship, the shared affiliation relationship indicating that the shared media track belongs to the at least two bitstreams.

16. The method according to claim 12, wherein
the immersive media includes non-time-sequence immersive media;
the encapsulating the relationship indication information and the N alternative bitstreams includes encapsulating the N alternative bitstreams as P media items, P being an integer greater than or equal to N; and
the relationship indication information is included in at least one of the P media items.

17. The method according to claim 12, wherein
the relationship indication information includes an alternative information data box, and
the alternative information data box includes information indicating alternative group identifiers, shared affiliation relationships, and association relationships between components of a same bitstream.

18. The method according to claim 12, further comprising:
generating signaling information including description information of the relationship indication information, the description information indicating the N alternative bitstreams having the alternative relationship.

19. The method according to claim 18, wherein the description information includes N preselection identifiers, each preselection identifier of the N preselection identifiers indicating one bitstream of the N alternative bitstreams, and the N preselection identifiers having a same coding identifier.

20. An apparatus for decoding immersive media data, the apparatus comprising:
processing circuitry configured to:
obtain a media file of immersive media, the immersive media including N alternative bitstreams, the media file including relationship indication information, the relationship indication information indicating an alternative relationship between the N alternative bitstreams, and N being an integer greater than 1; and
decode the media file based on the relationship indication information to present the immersive media.
